(19) United States
(12) Patent Application Publication
(10) Pub. No.: US 2026/0090959 A1
(43) Pub. Date: Apr. 2, 2026

(54) Multifunction Newborn Gavage Tube

(71) Applicants: Board of Regents, The University of Texas System, Austin, TX (US); ASCENSION HEALTH ALLIANCE, ST. LOUIS, MO (US)

(72) Inventors: Alan Groves, Austin, TX (US); Alissa Morris, Austin, TX (US); Angie Englert, Austin, TX (US); Christopher Rylander, Austin, TX (US); Iman Salafian, Austin, TX (US)

(21) Appl. No.: 19/113,194

(22) PCT Filed: Sep. 20, 2023
(86) PCT No.: PCT/US2023/074666

§ 371 Date: Mar. 19, 2025

Related U.S. Application Data
(60) Provisional application No. 63/376,356, filed on Sep. 20, 2022.

(51) Int. Cl. A61J 15/00

(52) U.S. Cl. CPC A61J 15/0073; A61J 15/0084; A61J 15/0092; A61J 15/0096; A61J 2200/70; A61J 2200/72

(57) ABSTRACT

Aspects of the present invention relate to a multi-lumen tube including a plurality of channels having a proximal end, a distal end and a length therebetween, wherein the plurality of channels comprises a first channel forming a feeding lumen, and a second channel forming a monitoring lumen, and each channel extends parallel to each other along at least a portion of the length of the tube, and wherein the proximal end is positioned outside of a subject's body and the distal end is positioned in the subject's stomach.

### CROSS-REFERENCE TO RELATED APPLICATIONS

This application claims priority to U.S. Provisional Patent Application No. 63/376,356, filed Sep. 20, 2022, the contents of which are incorporated by reference herein in its entirety.

### BACKGROUND OF THE INVENTION

Prematurely born infants require an orogastric or nasogastric tube to be placed to deliver milk feeds to infants who are unable to coordinate their own sucking and swallowing. These infants often also need a gavage tube to be placed to allow gas to escape from the stomach which was forced into the stomach by ventilatory support devices. If this gas is not allowed to escape from the stomach it progresses forwards and leads to distention of the abdomen (‘CPAP belly’) which can interfere with breathing and feed tolerance. At present the requirements for feeding and venting are addressed with a single lumen tube, meaning that gas cannot escape (‘vent’) while feeds are being given. As many very preterm infants struggle to tolerate feeds the clinical team often decide to give feeds more slowly through the tube, which therefore limits the time available for venting. In some cases, a second tube is passed to allow continuous venting while also continuously feeding.

Thus, there is a need in the art to develop a multifunctional tube to allow continuous feeding and venting to overcome significant obstacles to the optimal care of premature newborn infants. The present invention meets this need.

### SUMMARY OF THE INVENTION

Aspects of the present invention relate to a gavage tube having a multi-lumen tube having a plurality of channels having a proximal end, a distal end and a length therebetween, wherein the plurality of channels comprises a first channel forming a feeding lumen, and a second channel forming a monitoring lumen, and each channel extends parallel to each other along at least a portion of the length of the tube, and wherein the proximal end is positioned outside of a subject's body and the distal end is positioned in the subject's stomach.

In some embodiments, the multi-lumen tube has an outer diameter ranging between 1.0 and 10.0 mm. In some embodiments, the multi-lumen tube has an inner diameter ranging between 0.5 and 8.0 mm. In some embodiments, an outer surface of the multi-lumen tube comprises a plurality of textured markings for enhanced visibility. In some embodiments, the first channel comprises an axial feeding hole at the distal end of the channel.

In some embodiments, the first channel is fluidly connected to one selected from the group consisting of: a pump and a syringe. In some embodiments, the first channel has a diameter ranging between 0.3 and 5.0 mm. In some embodiments, the plurality of channels comprises a third channel forming a venting lumen. In some embodiments, the third channel comprises a plurality of lateral venting holes passing through the wall of the third channel, and through the wall of the multi-lumen tube. In some embodiments, the plurality of lateral venting holes have a diameter ranging between 0.5 and 3.0 mm. In some embodiments, the plurality of lateral venting holes are positioned at the distal end of the multi-lumen tube. In some embodiments, the plurality of lateral venting holes are positioned at the distal 2 cm of the multi-lumen tube.

In some embodiments, the gavage tube further includes a venting chamber fluidly connected to the third channel positioned at the proximal end of the multi-lumen tube. In some embodiments, the venting chamber comprises a first opening configured to be used for gastric gas profiling and an escape valve configured to allow gas efflux. In some embodiments, the escape valve is a single direction valve.

In some embodiments, the second channel further comprises a first lateral opening passing through the wall of the second channel, and through the wall of the multi-lumen tube, positioned 3-20 cm from the distal end of the tube. In some embodiments, the gavage tube further includes at least one temperature sensor positioned in the first opening of the second channel. In some embodiments, the at least one temperature sensor may be selected from the group consisting of a thermocouple, a thermistor, a thermos-diode, and combinations thereof. In some embodiments, the second channel further comprises a second lateral opening passing through the wall of the second channel, and through the wall of the multi-lumen tube, positioned 3-7 cm from the distal end of the tube. In some embodiments, the gavage tube further includes a second pressure sensor positioned in the second lateral opening of second channel.

In some embodiments, the gavage tube further includes a plurality of electrode rings positioned on an outer wall of the multi-lumen tube and configured to be used as ECG or EMG sensors, wherein the plurality of electrode rings are positioned along at least a portion of the length of the multi-lumen tube. In some embodiments, the plurality of electrode rings comprises between 2 and 10 electrode rings. In some embodiments, the plurality of electrode rings comprises at least a first, second and third electrode ring, wherein the first electrode ring is positioned 3 cm from the distal end of the multi-lumen tube, the second electrode ring is positioned 9 cm from the distal end of the multi-lumen tube, and the third electrode ring is positioned 10 cm from the distal end of the multi-lumen tube.

Aspects of the present invention relate to a method of providing nutrition to a subject having the steps of inserting a gavage tube including a multi-lumen tube having a plurality of channels having a proximal end, a distal end and a length therebetween through a nasal or oral cavity of the subject, wherein a first channel forms a feeding lumen having a proximal opening and distal axial opening in the multi-lumen tube, a second channel forms a monitoring lumen having a proximal opening and one or more lateral openings in the multi-lumen tube including one or more sensors positioned in each opening, and each channel extends parallel to each other along at least a portion of the length of the tube, and wherein the proximal end of the multi-lumen tube is positioned outside of a subject's body and the distal end is positioned in the subject's stomach, and, providing nutrition through the feeding lumen, and measuring at least one biometric of the subject with the one or more sensors during the step of providing nutrition through the feeding lumen.

Aspects of the present invention relate to a method of providing nutrition to a subject while simultaneously venting gas from the subject's stomach having the steps of inserting a gavage tube having a multi-lumen tube having a plurality of channels having a proximal end, a distal end and a length therebetween through a nasal or oral cavity of the subject, wherein a first channel forms a feeding lumen having a proximal opening a distal axial opening in the multi-lumen tube, a second channel forms a monitoring lumen having a proximal opening and one or more lateral openings in the multi-lumen tube including one or more sensors positioned in each opening, and a third channel forms a venting lumen having a proximal opening and a plurality of lateral vent holes in the multi-lumen tube, and each channel extends parallel to each other along at least a portion of the length of the tube, and wherein the proximal end of the multi-lumen tube is positioned outside of a subject's body and the distal end is positioned in the subject's stomach, and, providing nutrition through the feeding lumen, allowing the venting lumen to facilitate removal of gases from the subject's stomach during the step of providing nutrition through the feeding lumen, measuring at least one biometric of the subject with the one or more sensors during the step of providing nutrition through the feeding lumen. In some embodiments, the one or more sensors is selected from the group consisting of: temperature sensor, pressure sensor, light sensor, infrared sensor, humidity sensor, proximity sensor. In some embodiments, the gavage tube further includes a plurality of electrode rings positioned on an outer surface of the multi-lumen tube configured to measure ECG or EMG signals from the subject, and the method further includes the step of measuring ECG or EMG signals from the subject with the plurality of electrode rings during the step of providing nutrition through the feeding lumen.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1A and FIG. 1B depict a perspective view of an exemplary gavage tube of the present invention.

FIG. 2A and FIG. 2B depict a side view of an exemplary gavage tube of the present invention.

FIG. 3A and FIG. 3B depict a cross-sectional view of an exemplary gavage tube of the present invention having a feeding lumen, a venting lumen, and a monitoring lumen.

FIG. 4 depicts a side view of an exemplary venting chamber fluidly connected to the venting lumen.

FIG. 5 depicts a cross-sectional view of an exemplary monitoring lumen of the present invention.

FIG. 6 depicts a side view of an exemplary gavage tube having markings to allow better visualization during use.

FIG. 7A is a flowchart depicting an exemplary method of providing nutrition to a subject through a gavage tube according to aspects of the present invention. FIG. 7B is a flowchart depicting an exemplary method of providing nutrition to a subject while simultaneously venting gas from the subject's stomach using a gavage tube according to aspects of the present invention.

FIG. 8 depicts multiple views of an exemplary gavage tube of the present invention.

FIG. 9 depicts (top to bottom): a cross-sectional view, a top view, a front view, and a back view of an exemplary gavage tube of the present invention.

FIG. 10 depicts various perspective views of an exemplary gavage tube of the present invention.

FIG. 11A, FIG. 11B, and FIG. 11C show the pressure results for the vital sign monitoring from an exemplary gavage tube (e.g. trinity tube) of the present invention.

FIG. 12A, FIG. 12B, and FIG. 12C show the temperature results for the vital sign monitoring from an exemplary gavage tube of the present invention.

FIG. 13 show the ECG results for the vital sign monitoring from an exemplary gavage tube of the chest vs 3-7.

FIG. 14 show the ECG results for the vital sign monitoring from an exemplary gavage tube of the chest vs 2-9.

FIG. 15 is a diagram of a computing device that the present invention may operate on according to aspects of the present invention.

FIG. 16 is a side view of an EDI catheter.

FIG. 17 is a side view of an exemplary gavage tube according to aspects of the present invention.

FIG. 18 shows an enlarged side view of the distal end (left), and a cross-section view (right) of an exemplary gavage tube according to aspects of the present invention.

FIG. 19 shows an enlarged side view of the proximal (right), and a cross-section view (right) of an exemplary gavage tube according to aspects of the present invention.

FIG. 20 shows various views of an exemplary gavage tube and gavage tube system according to aspects of the present invention.

FIG. 21 shows the results for a pressure sensor calibration data for an exemplary gavage tube system.

FIG. 22 shows a life support set up for an animal model.

FIG. 23 shows an exemplary gavage tube set up in an animal's body according to aspects of the present invention.

FIG. 24A, FIG. 24B, FIG. 24C, and FIG. 24D show the data for ECG signals at 13 cm generated by an exemplary gavage tube of the present invention. FIG. 24A shows the data generated by ECG 1. FIG. 24B shows the data generated by ECG2. FIG. 24C shows the data generated by ECG3. FIG. 24D shows the data generated by ECG4.

FIG. 25A, FIG. 25B, FIG. 25C, and FIG. 25D show the data for ECG signals at 8 cm generated by an exemplary gavage tube of the present invention. FIG. 24A shows the data from ECG 1. FIG. 24B shows the data generated from ECG2. FIG. 24C shows the data generated from ECG3. FIG. 24D shows the data generated by ECG4.

FIG. 26 shows the ECG signal from the chosen electrodes (ECG3)

FIG. 27A, FIG. 27B, and FIG. 27C show the pressure and temperature data for 10 Hz and 60 BPM. FIG. 27A shows the data for pressure sensor 1 at the tip, FIG. 27B pressure sensor 2 at 5 cm from the tip, and FIG. 27C is esophageal temperature.

FIG. 28A, FIG. 28B, and FIG. 28C show the pressure and temperature data for 10 Hz and 80 BPM. FIG. 28A shows the data for pressure sensor 1 at the tip, FIG. 28B pressure sensor 2 at 5 cm from the tip, and FIG. 28C is esophageal temperature.

FIG. 29A and FIG. 29B show various views for an exemplary gavage tube comprising a first pressure sensor, a second pressure sensor, a temperature probe, and a plurality of ECG electrodes according to aspects of the present invention.

FIG. 30A, FIG. 30B, and FIG. 30C show data generated by an exemplary gavage tube. FIG. 30A shows pressure data, FIG. 30B shows temperature data, and FIG. 30C shows ECG data.

FIG. 31 shows placement in the body of a subject of an exemplary gavage tube according to aspects of the present invention.

FIG. 32 shows various views of an exemplary gavage tube and gavage tube system according to aspects of the present invention.

### DETAILED DESCRIPTION

It is to be understood that the figures and descriptions of the present invention have been simplified to illustrate elements that are relevant for a clear understanding of the present invention, while eliminating, for the purpose of clarity many other elements found in the field of gavage tubes. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

### Definitions

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, exemplary materials and methods are described herein. In describing and claiming the present invention, the following terminology will be used.

It is also to be understood that the terminology used herein is for the purpose of describing particular embodiments only, and is not intended to be limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, or +0.1% from the specified value, as such variations are appropriate.

The terms “patient,” “subject,” “individual,” and the like are used interchangeably herein, and refer to any animal amenable to the systems, devices, and methods described herein. The patient, subject or individual may be a mammal, and in some instances, a human.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Multifunction Newborn Gavage Tube

The present invention relates generally to a multi-lumen newborn gavage tube. In one embodiment, the gavage tube of the present invention comprises a dedicated feeding lumen coupled to a dedicated venting lumen and a monitoring lumen, together forming a single tube. Although described in some examples as having a dedicated venting lumen, it should be understood that the gavage tube of the present invention may comprise only a dedicated feeding lumen coupled to a dedicated monitoring lumen. In one embodiment, the gavage tube of the present invention is configured to allow continuous feeding and venting of gas from stomach. In one embodiment, the monitoring lumen allows for continuous monitoring of at least one parameter or signal, including but not limited to, temperature, ECG, transdiaphragmatic pressure, pH, impedance and etc. In one embodiment, the gavage tube of the present invention allow continuous monitoring of peristalsis. In one embodiment, the gavage tube of the present invention allows for quantification of work of breathing from transdiaphragmatic pressure. In one embodiment, the gavage tube of the present invention allows correction of central venous pressure for thoracic pressure. In one embodiment, the gavage tube of the present invention allows for ready visualization by bedside ultrasound.

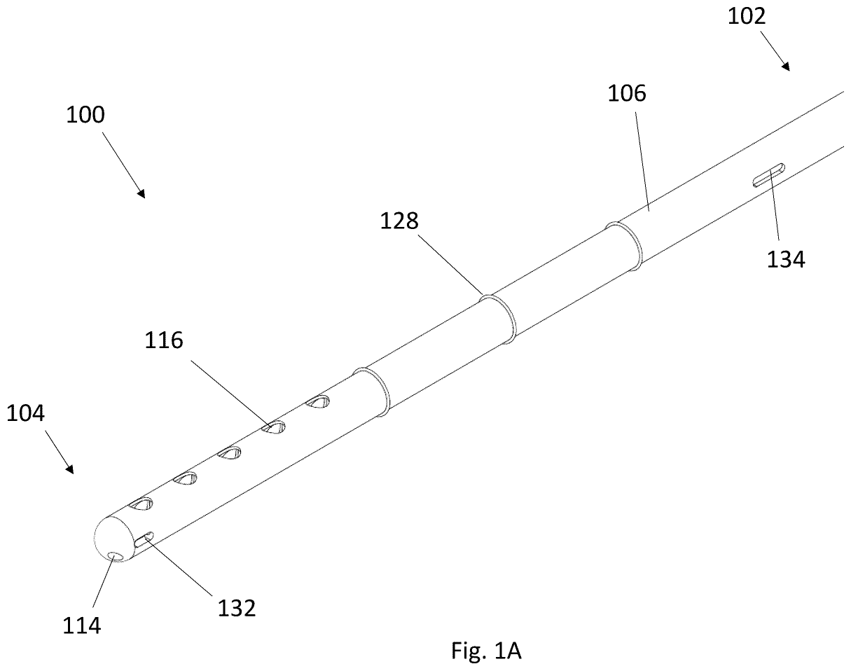

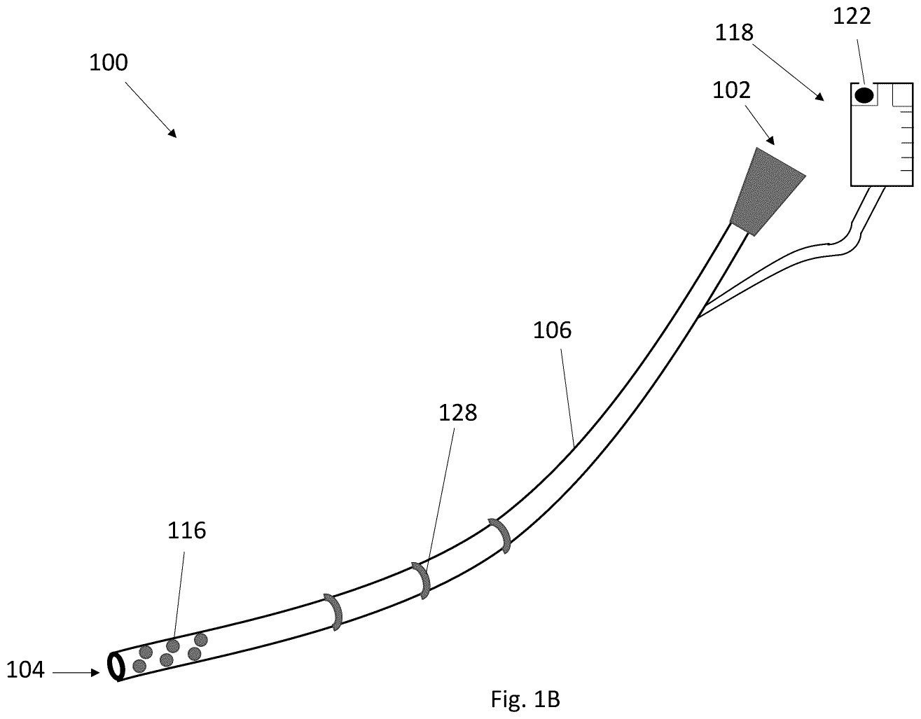

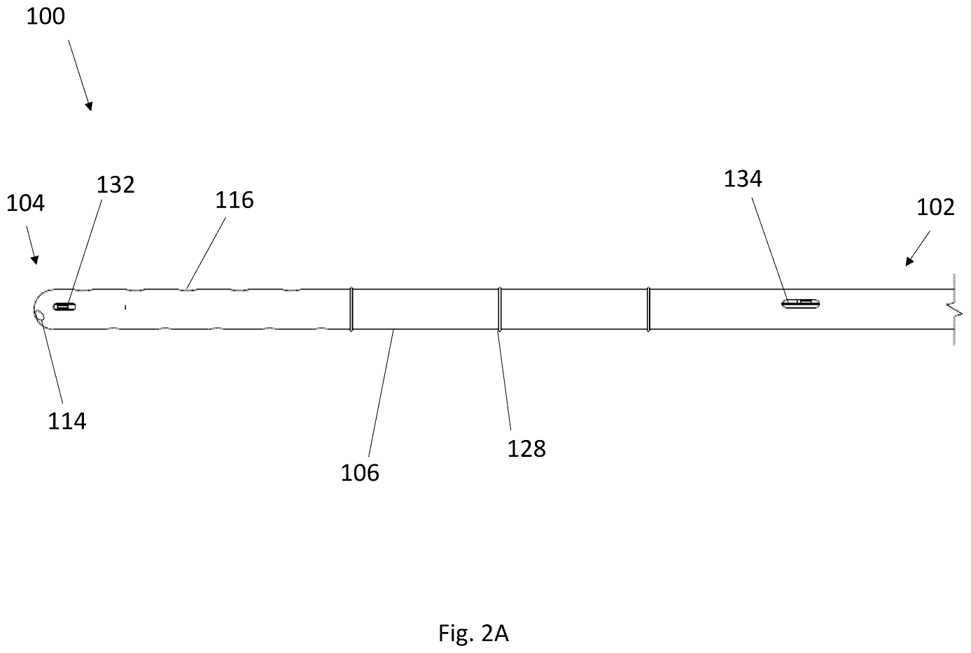

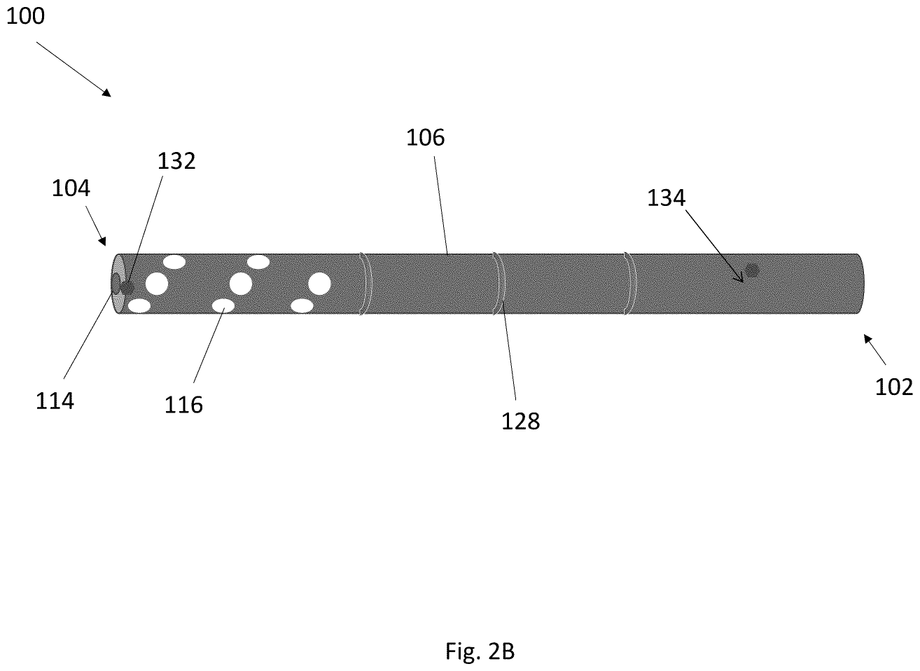

Referring now to FIG. 1A, FIG. 1B, FIG. 2A, and FIG. 2B, an exemplary gavage tube 100 of the present invention is shown. Gavage tube 100 comprises a proximal end 102, a distal end 104, and a multi-lumen tube 106 therebetween.

As contemplated herein, multi-lumen tube 106 may have an outer diameter ranging between 1.0 and 10.0 mm (3-30 Fr). In one embodiment, multi-lumen tube 106 has an outer diameter of about 2.7 mm or 8 French. In one embodiment, multi-lumen tube 106 may have an inner diameter ranging between 0.5 and 8.0 mm. In one embodiment, multi-lumen tube 106 has an inner diameter of about 2.1 mm. In one embodiment, multi-lumen tube 106 has a wall thickness of about 0.3 mm. In one embodiment, multi-lumen tube 106 may have a length ranging between 20 and 50 cm. In one embodiment, distal end 104 of multi-lumen tube 106 may be tapered. In one embodiment, distal end 104 of multi-lumen tube 106 may be flat. In one embodiment, distal end 104 of multi-lumen tube 106 may have any other suitable shapes known to one skilled in the art. Although example dimensions for multi-lumen tube 106 are provided, sized for an infant-size subject, multi-lumen tube 106 may be sized for any intended subject, not limited to human infants.

In one embodiment, distal end 104 may be positioned within the subject's stomach. In one embodiment, distal end 104 may be positioned past the stomach and within the subject's duodenum.

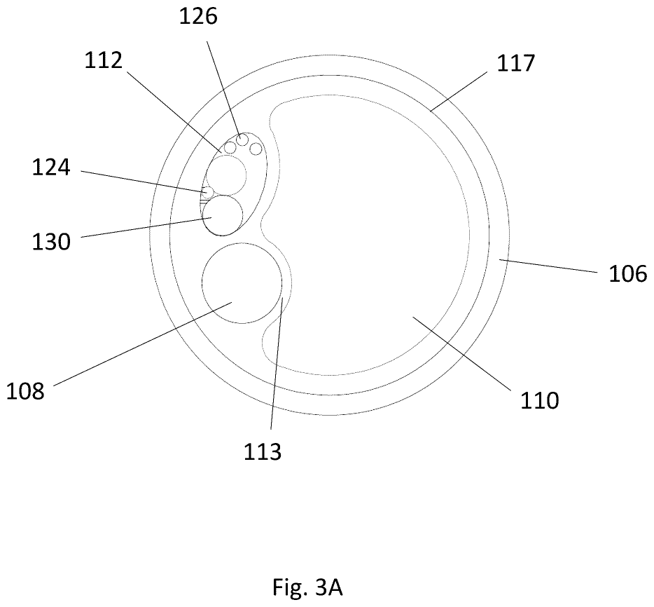

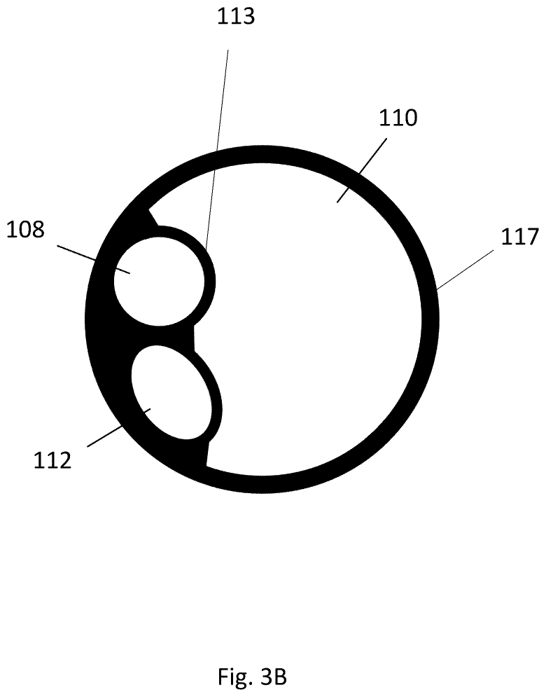

Multi-lumen tube 106 comprises a first channel forming a feeding lumen 108, and a second channel forming a monitoring lumen 112. In some embodiments, multi-lumen tube 106 further comprises a third channel forming a venting lumen 110. In some embodiments, feeding lumen 108 is separated from venting lumen 110 and monitoring lumen 112 by a central wall 113 (FIG. 3A & FIG. 3B). In one embodiment, central wall 113 may be as thick as multi-lumen tube 106 wall. In one embodiment, central wall 113 is thicker than multi-lumen tube 106 wall. In one embodiment, central wall 113 may be thinner than multi-lumen tube 106 wall. The relative thickness of central wall 113 and the multi-lumen tube 106 outer wall can vary depending on the application and the material used to construct gavage tube 100. In some embodiments, multi-lumen tube 106 comprises an outer surface comprising a plurality of markings for enhanced visibility. In some embodiments, the markings are textured markings and/or radiology markings.

Feeding lumen 108 comprises an axial feeding hole 114 positioned at distal end 104. In one embodiment, feeding hole 114 may have a diameter smaller than the diameter of feeding lumen 108. In one embodiment, feeding hole 114 may have the same diameter as feeding lumen 108. Feeding lumen 108 may be connected to any suitable device configured to allow introduction of feeding material at proximal end 102. In one embodiment, feeding lumen 108 may be connected to a syringe at proximal end 102. In one embodiment, feeding lumen 108 may be connected to a pump at proximal end 102. Feed delivery by pump allows adjusting the feeding rate between 0.1-100 ml/hr. In one embodiment, the pump is configured to allow achieving standard NICU syringe drivers pressures. In one exemplary embodiment, 100 ml/hr allows delivery of 160 ml/kg/day to a 2.5 kg baby in 3 hourly feeds given over 30 minutes.

Feeding lumen 108 has a diameter ranging between 0.1 and 4.0 mm. In one embodiment, feeding lumen 108 has a diameter of about 0.5 mm. In one embodiment, feeding lumen 108 may have any cross-sectional shapes including but not limited to circular, oval, etc. In one embodiment, feeding lumen 108 may have a generally circular cross section. Although example dimensions for feeding lumen 108 are provided, sized for an infant-size subject, feeding lumen 108 may be sized for any intended subject, not limited to human infants.

Venting lumen 110 comprises a plurality of lateral venting holes 116 for gastric venting on outer venting lumen wall 117. In one embodiment, plurality of lateral venting holes 116 are positioned close to distal end 104. In one embodiment, plurality of lateral venting holes 116 are positioned in the distal 2 cm of venting lumen 110. In one embodiment, plurality of lateral venting holes 116 may be arranged in any suitable configuration. In one embodiment, plurality of lateral venting holes 116 may be positioned on at least one vertical line extending from distal end 104 towards proximal end 102. In one embodiment, plurality of lateral venting holes 116 may be positioned on at least one horizontal line. In one embodiment, plurality of lateral venting holes 116 may be positioned on at least one helical line extending from distal end 104 towards proximal end 102 (FIG. 2). In one embodiment, plurality of lateral venting holes 116 have a diameter ranging between 0.5 and 3.0 mm. The size, number and placement of the venting holes can vary depending on the application of gavage tube 100. For example, larger babies having larger stomachs may accommodate larger venting holes and greater number of venting holes. In some embodiments, plurality of lateral venting holes 116 are equally spaced on two different planes. In some embodiments, plurality of lateral venting holes 116 may be located at 7 and 10 o'clock positions on multi-lumen tube 106. In some embodiments, plurality of lateral venting holes 116 are sets of linear holes. In some embodiments, plurality of lateral venting holes 116 are 3 sets of linear holes. In some embodiments, plurality of lateral venting holes 116 are at least one hole in multi-lumen tube 106 in fluid communication with venting lumen 110. In some embodiments, the plurality of lateral venting holes are positioned at the distal 2 cm of the second channel.

Venting lumen 110 has a total internal cross-sectional area ranging between 1 and 6 mm². In some embodiments, venting lumen 110 having a 3 mm² cross-sectional area with length of 30 cm allows venting rate of approximately 180 ml/minute from the stomach. In one embodiment, venting lumen 110 has a generally crescent shaped cross-section. Although example dimensions for venting lumen 110 are provided sized for an infant-size subject, venting lumen 110 may be sized for any intended subject, not limited to human infants.

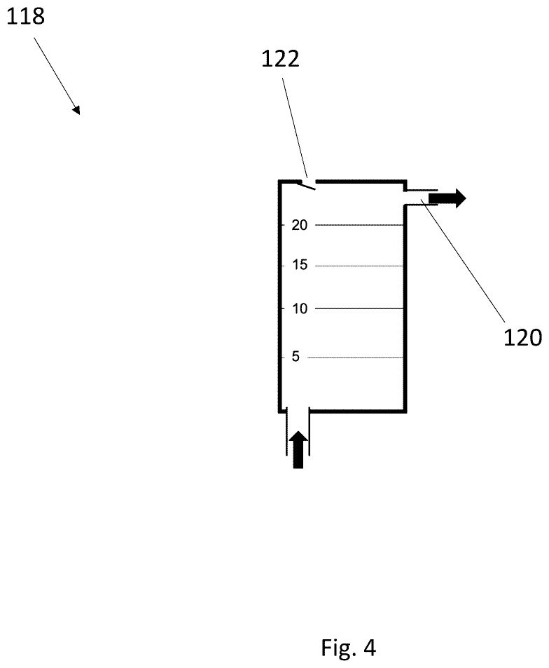

In one embodiment, venting lumen 110 may be left open at proximal end 102 for venting. In one embodiment venting lumen 110 may be fluidly connected to a venting chamber 118 at proximal end 102 (FIG. 4). Venting chamber 118 is configured to allow small volumes of gastric secretions and feeding material including but not limited to milk, formula, or other liquid nutrition to come out of venting lumen 110 during emesis or agitation, before then gradually returning to the child's stomach, maximizing feed tolerance. In one embodiment, venting lumen 110 may be connected to venting chamber 118 through any suitable mechanism known to one skilled in the art including but not limited to tubing, etc. Venting chamber 118 may have any suitable volume known to one skilled in the art for reflux and return of milk in closed space. In one embodiment, venting chamber 118 has a 20 ml chamber volume. In one embodiment, venting chamber 118 has a volume of more than 20 ml. In one embodiment, venting chamber 118 has a volume of less than 20 ml.

Venting lumen 110 may be replaced at regular intervals, e.g., daily, while gavage tube 100 remains in place. In some embodiments, venting lumen 100 is replaced after a period of time, including, but not limited to, daily, every other day, every 3 days, every 4 days, 3 times a week, once a week. In some embodiments, the venting chamber may be permanently attached to the venting lumen. In some embodiments, the venting chamber is detachable such that the venting chamber can be replaced while leaving the remainder of the gavage tube in place.

Venting chamber 118 comprises a first opening 120 and an escape valve 122. First opening 120 may be positioned anywhere on venting chamber 118 and is configured to be used for gastric gas profiling including but not limited to CO₂, metabolome, microbiome, etc. Escape valve 122 may be positioned anywhere on venting chamber 118 and is configured to allow gas efflux. In one embodiment, escape valve 122 may be a single direction valve. In one embodiment, escape valve 122 may be any suitable valve known to one skilled in the art.

Multi-lumen tube 106 may comprise various openings to enable sensors to take in-situ environmental readings. Referring now to FIG. 1A, multi-lumen tube 106 may comprise first sensor opening 132 located near distal end 104 and second sensor opening 134 located near proximal end 102. First sensor opening 132 may house one or more sensors and form a fluid connection with monitoring lumen 112. Second sensor opening 134 may house one or more sensors and form a fluid connection with monitoring lumen 112. Although in one example multi-lumen tube 106 is described as having various sensors positioned within the tubes and lumens of multi-lumen tube 106, it should be understood that any sensor of the present invention may be configured and/or attached to any positions on the exteriors of the individual tubes, or to any position on the exterior of multi-lumen tube 106 itself. It should also be appreciated that any sensor may be embedded in the walls of the individual tubes, or the wall of multi-lumen tube 106, and therefor the sensors of gavage tube 108 may be positioned inside, embedded in, or on the exterior of the tubes and/or multi-lumen tube 106, and any combinations thereof.

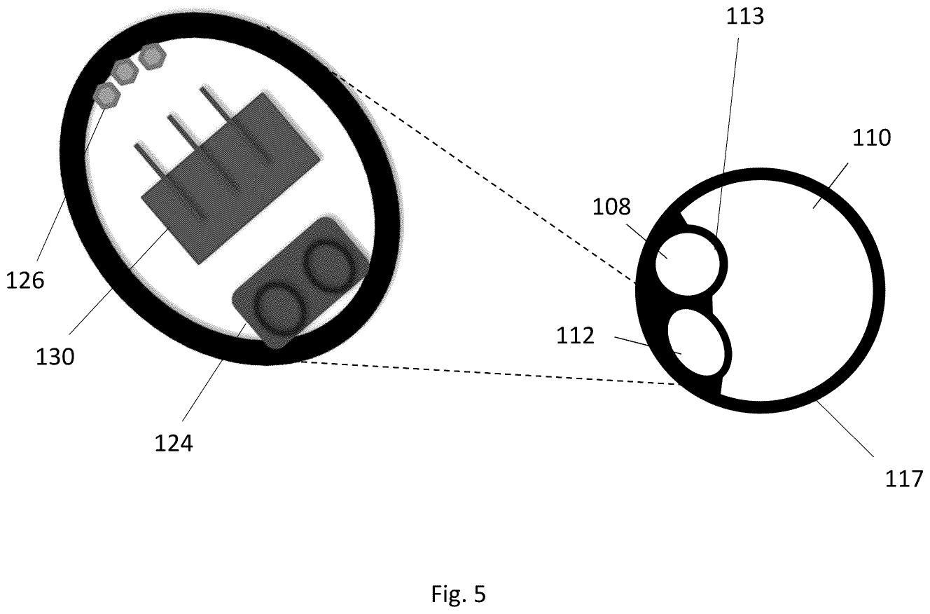

Referring now to FIG. 5, an exemplary monitoring lumen 112 of the present invention is shown. Monitoring lumen 112 is configured to provide electrocardiogra respiration monitoring, temperature, and optional other monitoring functionality. In one embodiment, monitoring lumen 112 comprises a temperature thermocouple 124, configured to provide reliable esophageal temperature, without need for skin sensors. In one embodiment, temperature thermocouple 124 is positioned at distal end 104, extends toward proximal end 102 and ends at approximately 3 to 7 cm from distal end 104. In one embodiment, temperature thermocouple 124 may end at any other suitable distance within monitoring lumen 112. In one embodiment, the end of temperature thermocouple 124 integrates into the wall of monitoring lumen 112. In one embodiment, the end of temperature thermocouple 124 does not integrate to the wall of monitoring lumen 112. In one embodiment, thermocouple 124 extends through monitoring lumen 112 and terminates in first sensor opening 132 and provides a temperature reading in the stomach cavity. In one embodiment, thermocouple 124 extends through monitoring lumen 112 and terminates in first sensor opening 134 and provides a temperature reading in the esophagus. In one embodiment, temperature thermocouple may be any suitable thermocouple including but not limited to TE micro-thermocouple, model 605 which is sized down to 0.08×0.16 mm and is 44 gauge. In one embodiment, any other temperature sensors can be used in place of the illustrated thermocouple including but not limited to a thermistor, a thermos-diode, etc.

In one embodiment, monitoring lumen 112 further comprises a catheter 126 configured to measure the electrical activity of the diaphragm (Edi) using neurally adjusted ventilatory assist (NAVA) technology. For example, catheter 126 may be a Getinge Edi NAVA catheter having 10 electrodes at 6 mm separations in a 6 Fr tube. In one embodiment, the electrodes may have a stainless steel coating. In one embodiment, the electrodes may have any other suitable coating known to one skilled in the art.

In some embodiments, catheter 126 comprises at least one electrode wire configured to be connected to at least one electrode ring 128. In some embodiments, gavage tube 100 comprises at least one electrode positioned on the outside of multi-lumen tube 106.

In one embodiment, gavage tube 100 may further comprise a plurality of electrode rings 128 positioned on the outer wall of multi-lumen tube 106 that when inserted, make contact with the subject's esophagus. Plurality of electrode rings 128 are configured to be used as ECG sensors. Plurality of electrode rings 128 give reliable heart rate without need for any skin sensors. In one embodiment, gavage tube 100 may comprise at least 2 electrode rings 128. In one embodiment, the at least 2 electrode rings 128 may be positioned 5-15 mm apart from each other. In one embodiment, gavage tube 100 may comprise 3 electrode rings 128. In one embodiment, the three electrode rings 128 are positioned at 2, 3 and 4 cm distance from distal end 104. In some embodiments, gavage tube 100 has 2 electrode rings, 3 electrode rings, 4 electrode rings, 5 electrode rings, 6 electrode rings, 7 electrode rings, 8 electrode rings, 9 electrode rings, 10 electrode rings, 11 electrode rings, 12 electrode rings, 13 electrode rings, 14 electrode rings, 15 electrode rings. In some embodiments, the spacing between the electrode rings is, but not limited to, about 2 mm, 3 mm, 4 mm, 5 mm, 6 mm, 7 mm, 8 mm, 9 mm, or about 10 mm. In one embodiment, plurality of electrode rings 128 may have a stainless steel coating. In one embodiment, plurality of electrode rings 128 may have any other suitable coating known to one skilled in the art.

In one embodiment, monitoring lumen 112 further comprises at least one pressure sensor 130. In one embodiment, monitoring lumen 112 may have 2 pressure sensors, with one positioned at distal end 104 and one positioned 3-7 cm from distal end 104. In one embodiment, at least one pressure sensor 130 may be positioned in a catheter with side holes for measurement of esophageal pressure. In one embodiment, pressure sensor 130 extends through monitoring lumen 112 and terminates in first sensor opening 132 and provides a pressure reading in the stomach cavity. In one embodiment, pressure sensor 130 extends through monitoring lumen 112 and terminates in first sensor opening 134 and provides a pressure reading in the esophagus. In one embodiment, at least one pressure sensor may be microelectromechanical system (MEMS) pressure sensors. In one embodiment, the MEMS pressure sensor may be 0.3×0.3 mm in size. Monitoring lumen 112 has a diameter ranging between 0.3 and 1.5 mm. In one embodiment, monitoring lumen 112 has a diameter of about 0.5 mm. In one embodiment, monitoring lumen 112 may have any cross-sectional shapes including but not limited to circular, oval, etc. In one embodiment, monitoring lumen 112 has a total internal cross-sectional aera of 0.2 mm².

In one embodiment, gavage tube 100 may be a single use device. In one embodiment, gavage tube 100 may be sterilized. In one embodiment, gavage tube 100 may be sterilized with any suitable method known to one skilled in the art including but not limited to UV sterilization.

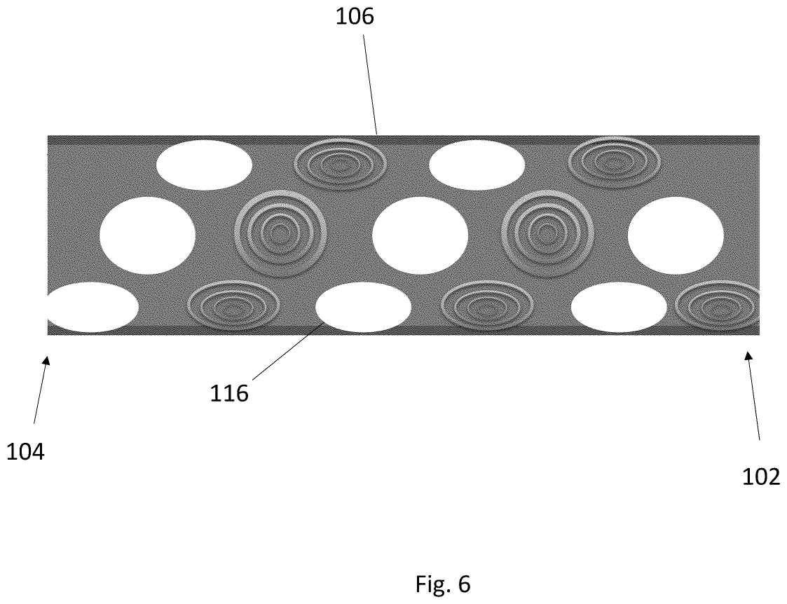

In one embodiment, outer surface of multi-lumen tube 106 is printed with markings, including but not limited to measurement lines for placing the tube at a correct depth in a subject. In one embodiment outer surface of multi-lumen tube 106 may comprises one or more radiopaque markings, lines, spirals, etc. configured to be visible on a radiograph (X-ray), ultrasounds, etc. (FIG. 6). ‘In one embodiment the outer surface of the tube may comprise one or more radio-opaque markings configured to be visible on a radiograph (x-ray). In one embodiment the outer surface of the tube will be textured with lines, spirals, etc configured to enhance visibility on ultrasound.

In one embodiment, gavage tube 100 may be made of any suitable material known to one skilled in the art including but not limited to a soft, flexible plastic such as polymeric silicone (such as SILASTIC®, Dow Corning, Midland, Mich.), polyurethane, silicone rubber, nylon, polyethylene terephthalate, latex, or combinations thereof.

In one embodiment, gavage tube 100 may be made from a single type of material. In one embodiment, gavage tube 100 may be made from multiple type of material. In one embodiment, feeding tube 108 and venting tube 110 may be made from different type of material. In one embodiment, feeding tube 108 and venting tube 110 may be made from a single type of material. In some embodiments, venting tube 110 may be made from a stiffer, less flexible material. In some embodiments, venting tube 110 may be made from a softer, more flexible material.

In one embodiment, gavage tube 100 may be used for neonates, physically challenged infants, especially premature neonates, neonates with an immature respiratory system and medically fragile infants. Although an example gavage tube 100 is provided intended for use by subjects up to age 1, the example also includes infants and children up to and including age 2. However, it is to be noted that the example gavage tube 100 provided is sized for infants, and a gavage tube 100 may be sized appropriately for any intended subject of any intended age, and the subjects need not be human.

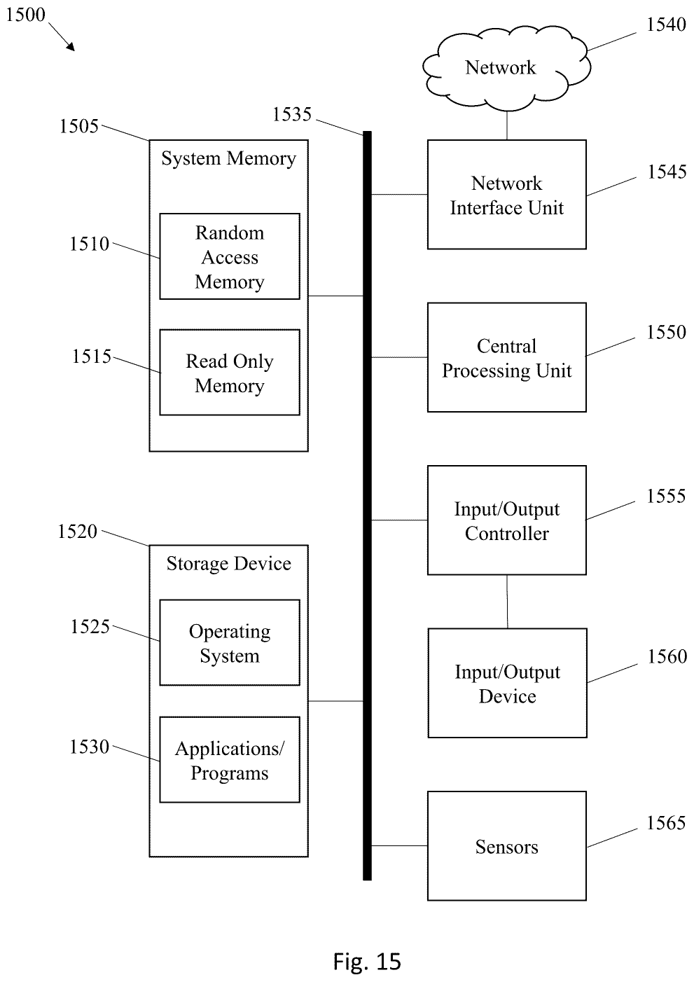

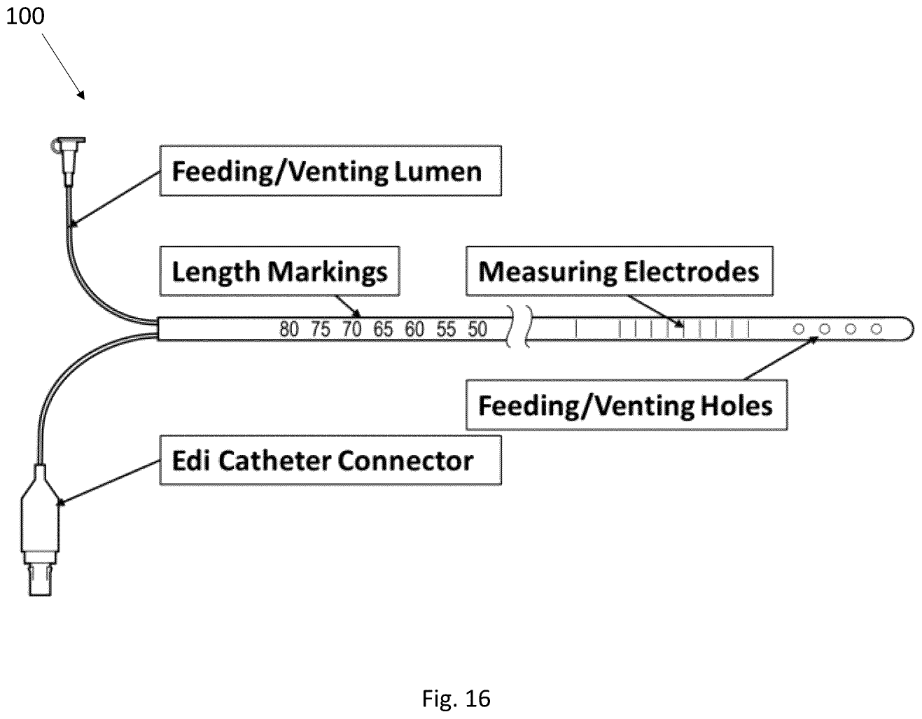

In one embodiment, gavage tube 100 may further comprise a controller configured to monitor and store any data including but not limited to the feeding flow rate, feeding frequency, etc. Further, the controller is configured to receive data from monitoring lumen 112 and plurality of electrode rings 128. In some embodiments, the controller comprises computing device 1500 of FIG. 15. In some embodiments, pressure within the subject is measured remotely using a membrane positioned at the distal end of the monitoring lumen. In this ‘remote sensing’ approach monitoring lumen 108 measures 0.05-0.3 mm in internal diameter. The distal end of monitoring lumen 108 is open to the inside of the esophagus. In some embodiments, monitoring lumen comprises one or more thin membranes enclosing the distal end of the lumen. In some embodiments, the proximal end of monitoring lumen 108 is positioned outside the patient and is connected to any suitable sensor or pressure monitor.

### Computing Device

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled, or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

FIG. 15 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 15 depicts an illustrative computer architecture for a computer 1500 for practicing the various embodiments of the invention. The computer architecture shown in FIG. 15 illustrates a conventional personal computer, including a central processing unit 1550 (“CPU”), a system memory 1505, including a random access memory 1510 (“RAM”) and a read-only memory (“ROM”) 1515, and a system bus 1535 that couples the system memory 1505 to the CPU 1550. A basic input/output system containing the basic routines that help to transfer information between elements within the computer, such as during startup, is stored in the ROM 1515. The computer 1500 further includes a storage device 1520 for storing an operating system 1525, application/program 1530, and data.

The storage device 1520 is connected to the CPU 1550 through a storage controller (not shown) connected to the bus 1535. The storage device 1520 and its associated computer-readable media provide non-volatile storage for the computer 1500. Although the description of computer-readable media contained herein refers to a storage device, such as a hard disk or CD-ROM drive, it should be appreciated by those skilled in the art that computer-readable media can be any available media that can be accessed by the computer 1500.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 1500 may operate in a networked environment using logical connections to remote computers through a network 1540, such as TCP/IP network such as the Internet or an intranet. The computer 1500 may connect to the network 1540 through a network interface unit 1545 connected to the bus 1535. It should be appreciated that the network interface unit 1545 may also be utilized to connect to other types of networks and remote computer systems.

The computer 1500 may also include an input/output controller 1555 for receiving and processing input from a number of input/output devices 1560, including a keyboard, a mouse, a touchscreen, a camera, a microphone, a controller, a joystick, or other type of input device. Similarly, the input/output controller 1555 may provide output to a display screen, a printer, a speaker, or other type of output device. The computer 1500 can connect to the input/output device 1560 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 1520 and/or RAM 1510 of the computer 1500, including an operating system 1525 suitable for controlling the operation of a networked computer. The storage device 1520 and RAM 1510 may also store one or more applications/programs 1530. In particular, the storage device 1520 and RAM 1510 may store an application/program 1530 for providing a variety of functionalities to a user. For instance, the application/program 1530 may comprise many types of programs such as a word processing application, a spreadsheet application, a desktop publishing application, a database application, a gaming application, internet browsing application, electronic mail application, messaging application, and the like. According to an embodiment of the present invention, the application/program 1530 comprises a multiple functionality software application for providing word processing functionality, slide presentation functionality, spreadsheet functionality, database functionality and the like.

The computer 1500 in some embodiments can include a variety of sensors 1565 for monitoring the environment surrounding and the environment internal to the computer 1500. These sensors 1565 can include a Global Positioning System (GPS) sensor, a photosensitive sensor, a gyroscope, a magnetometer, thermometer, a proximity sensor, an accelerometer, a microphone, biometric sensor, barometer, pressure sensor, ECG sensor, humidity sensor, radiation sensor, or any other suitable sensor.

### Method of Use

The present invention provides a method of providing continuous feeding to a subject through a gavage tube, while allowing continuous venting of gas from stomach. In one embodiment, the present invention provides a method of continuous monitoring of at least one including but not limited to temperature, ECG, pressure, etc. In one embodiment, the method of the present invention allows continuous monitoring of gastric peristalsis. In one embodiment, the present invention provides a method of measuring esophageal or airway pressure to allow titration of the amount of gas flow delivered by high flow cannula to target a clinically desired pressure. In one embodiment, the present invention provides a method of quantifying the work of breathing from transdiaphragmatic pressure. In one embodiment, the present invention provides a method of correcting central venous pressure for thoracic pressure. In one embodiment, the method of present invention allows for ready visualization by bedside ultrasound. In one embodiment, the method of present invention allows for introducing the feeding material with any suitable flow rate based on need. Further, the method of present invention allows for storing data and running programs, and for sending and receiving data over a network, if needed.

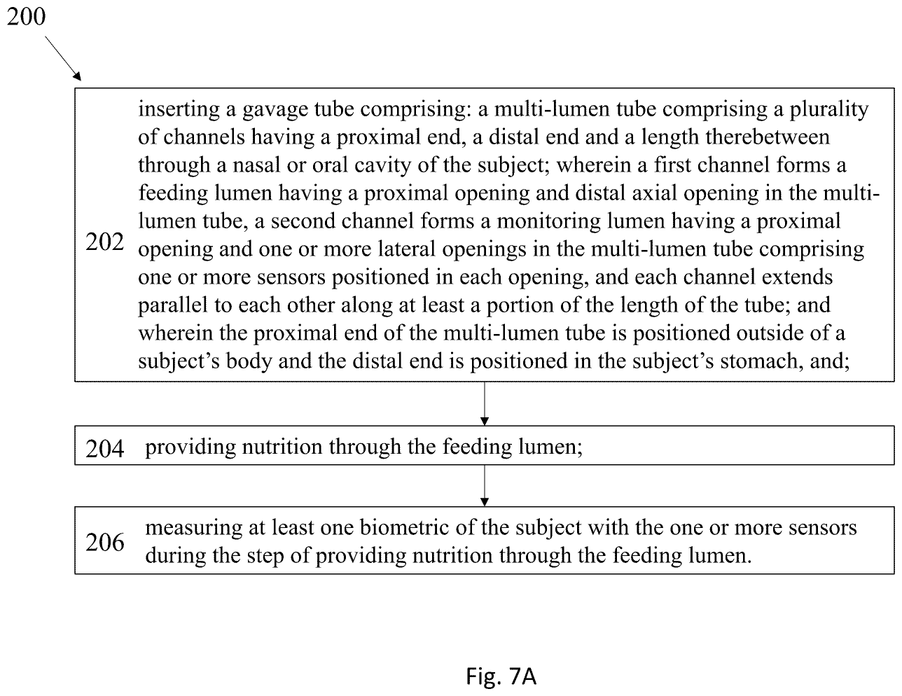

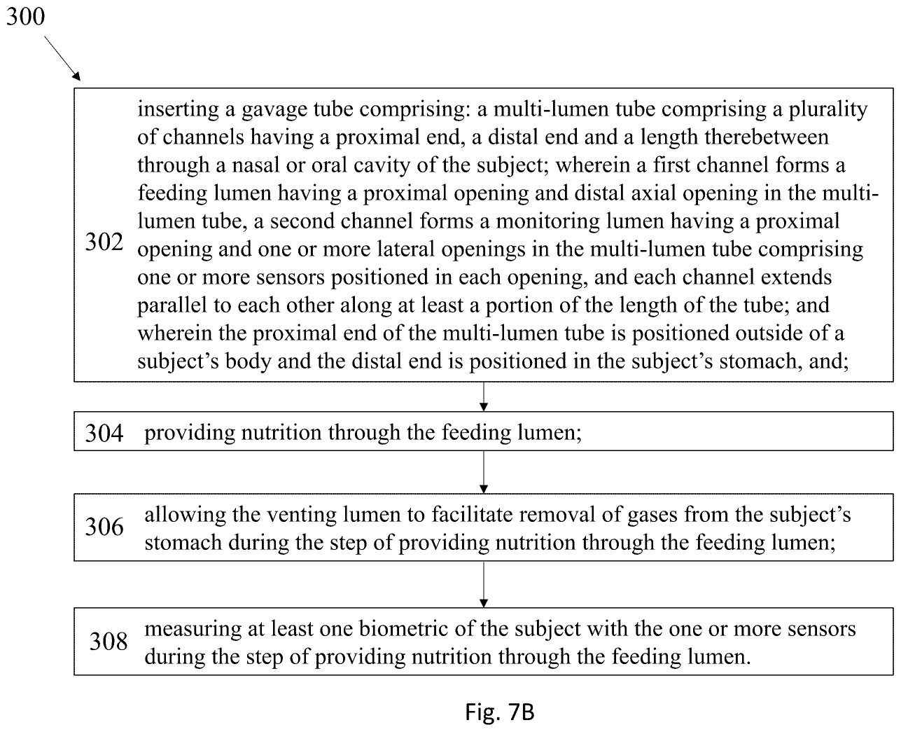

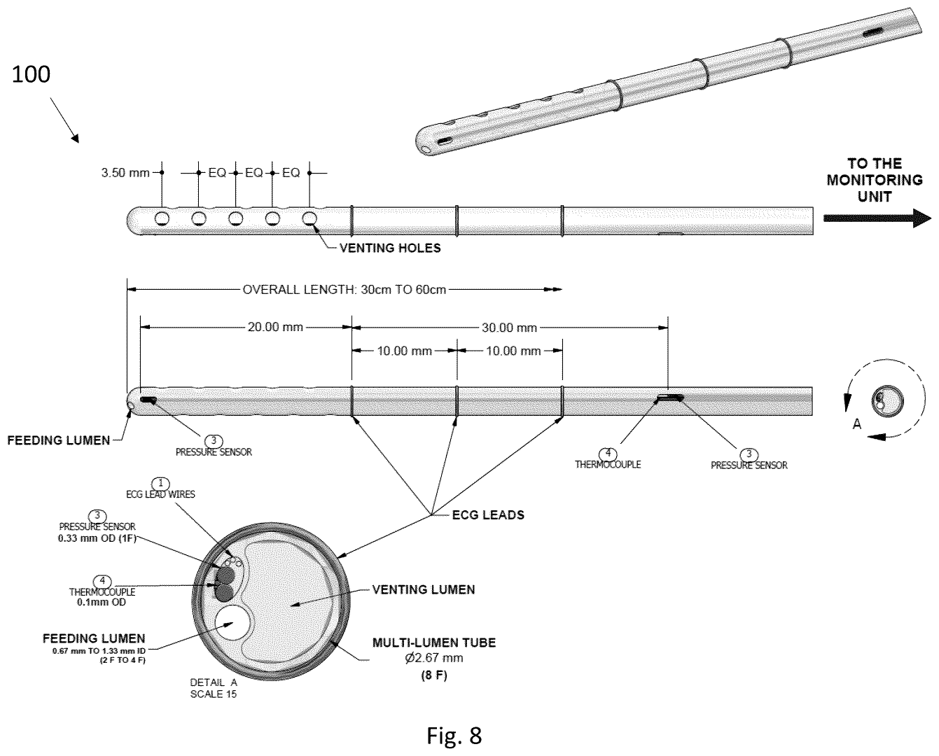

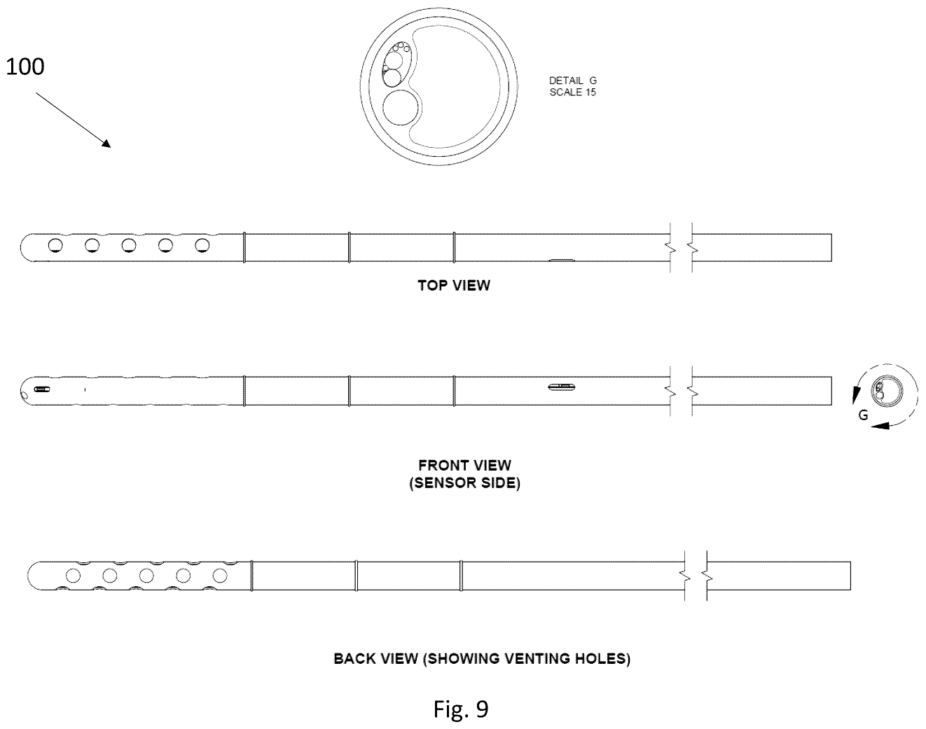

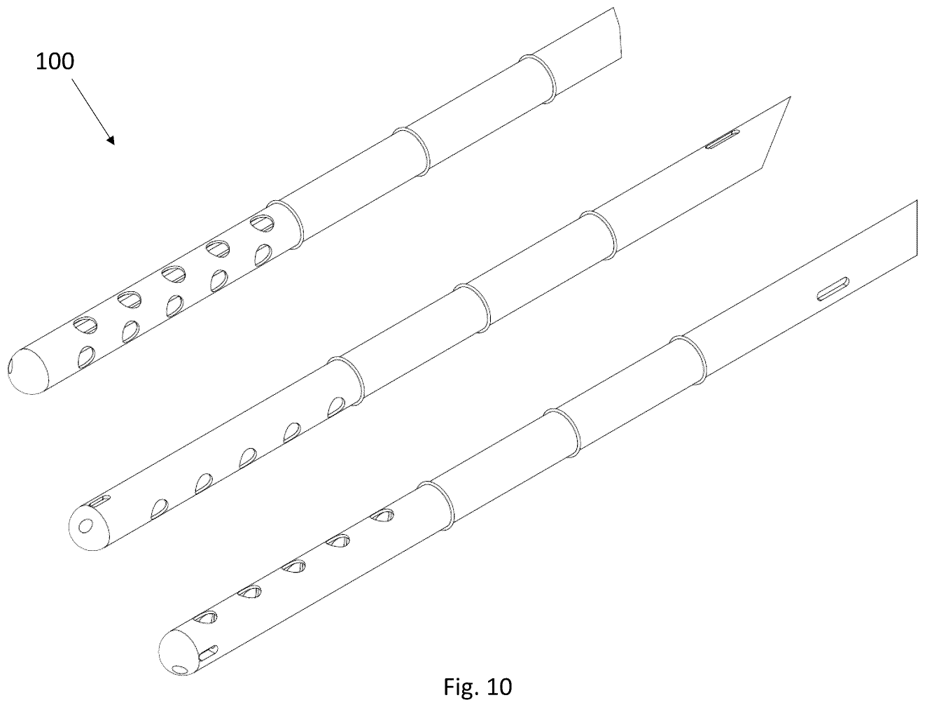

Referring now to FIG. 7A, aspects of the present invention relate to a method 200 of providing nutrition to a subject, comprising the steps of: 202 inserting a gavage tube comprising: a multi-lumen tube comprising a plurality of channels having a proximal end, a distal end and a length therebetween through a nasal or oral cavity of the subject; wherein a first channel forms a feeding lumen having a proximal opening and distal axial opening in the multi-lumen tube, a second channel forms a monitoring lumen having a proximal opening and one or more lateral openings in the multi-lumen tube comprising one or more sensors positioned in each opening, and each channel extends parallel to each other along at least a portion of the length of the tube; and wherein the proximal end of the multi-lumen tube is positioned outside of a subject's body and the distal end is positioned in the subject's stomach, and; 204 providing nutrition through the feeding lumen; and 206 measuring at least one biometric of the subject with the one or more sensors during the step of providing nutrition through the feeding lumen. Referring now to FIG. 7B, aspects of the present invention relate to a method 300 of providing nutrition to a subject while simultaneously venting gas from the subject's stomach, comprising: 302 inserting a gavage tube comprising: a multi-lumen tube comprising a plurality of channels having a proximal end, a distal end and a length therebetween through a nasal or oral cavity of the subject; wherein a first channel forms a feeding lumen having a proximal opening a distal axial opening in the multi-lumen tube, a second channel forms a monitoring lumen having a proximal opening and one or more lateral openings in the multi-lumen tube comprising one or more sensors positioned in each opening; and a third channel forms a venting lumen having a proximal opening and a plurality of lateral vent holes in the multi-lumen tube, and each channel extends parallel to each other along at least a portion of the length of the tube; and wherein the proximal end of the multi-lumen tube is positioned outside of a subject's body and the distal end is positioned in the subject's stomach, and; 304 providing nutrition through the feeding lumen; 306 allowing the venting lumen to facilitate removal of gases from the subject's stomach during the step of providing nutrition through the feeding lumen; 308 measuring at least one biometric of the subject with the one or more sensors during the step of providing nutrition through the feeding lumen.

In some embodiments, the one or more sensors is selected from the group consisting of: temperature sensor, pressure sensor, light sensor, infrared sensor. In some embodiments, the gavage tube further comprises a plurality of electrode rings positioned on an outer surface of the multi-lumen tube configured to measure ECG or EMG signals from the subject; and the method further comprises the step of measuring ECG or EMG signals from the subject with the plurality of electrode rings during the step of providing nutrition through the feeding lumen.

In steps 204 and 304, feeding material is provided through the feeding lumen. In one embodiment, feeding material may be one including but not limited to milk, formula, or other liquid nutrition material known to one skilled in the art. In one embodiment, feeding lumen may be connected to one including but not limited to a syringe, a pump, etc. at proximal end such that it allows controlling the flow rate of the feeding material to the subject. In one embodiment, flow rate of the feeding material may be ranging between 0.1 and 100 ml/hr. In step 206, the venting lumen is allowed to facilitate removal of gases from the subject's stomach during the step of providing nutrition through the feeding lumen. In one embodiment, the venting lumen is positioned past the stomach and within the subject's duodenum.

In certain aspects, the present method is used to provide continuous feeding and venting of an infant, such as a premature neonate. In certain embodiments, the method comprises inserting the gavage tube through the nasal or oral cavity of an infant subject, such as a neonates, physically challenged infants, premature neonates, neonates with an immature respiratory system and medically fragile infants.

In certain embodiment, the present method comprises monitoring and storing any data including but not limited to the feeding flow rate, feeding frequency, etc. using a controller. In one embodiment, the method comprises receiving data from the monitoring lumen and plurality of electrode rings.

In some embodiments, the disclosed method comprises providing respiratory support to target a specific positive end expiratory pressure (PEEP), and/or measuring PEEP. Subjects (e.g. infants) receiving a common modality of breathing support called high flow nasal cannula (HFNC) receive some level of PEEP. The level of PEEP is crucial in providing adequate breathing support. By measuring airway pressure (PEEP) inside the subject, one can titrate how much flow is provided via various apparatus (e.g. HFNC apparatus) to target the desired PEEP. This approach is defined herein as pressure targeted high flow (PTHF) therapy.

In some embodiments, the disclosed method comprises monitoring of airway pressure at any distance along the length of the gavage tube, including in the esophagus, but also in the nasal cavity, oral cavity, nasopharynx, oropharynx, laryngopharynx, hypopharynx or upper esophagus.

In some embodiments, the disclosed method comprises monitoring pressure by placing any suitable sensor directly within a tube or channel forming a lumen in gavage tube 100 of the present invention and inserting the gavage tube into the airway of the subject.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1: Total Length of Feeding Tube

The inventors have collected data from clinical subjects suggesting that the total length of a feeding tube indwelling inside an infant will most frequently be in the range of 12-20 cm. A device length of 20-50 cm is therefore suggested to allow some length outside the infant for securement and connection to interfaces. This shorter length will assist gas venting as resistance to gas flow increases in proportion to tube length.

### Example 2: Length of Feeding Tube Below the Level of the Diaphragm

The inventors have collected data from clinical subjects suggesting that the length of a feeding tube below the level of the diaphragm will most frequently be in the range of 1.0-4.0 cm. The placement position of the proximal pressure sensor and temperature sensor is therefore estimated to be 5 cm (range 3-7 cm) from the distal tip.

### Example 3: Maximum Feed Rate

The inventors have collected in vitro data from vascular catheters suggesting that continuous feeds can be administered through a 0.5 mm diameter lumen at rates of up to 100 ml/hour without excessive pressure being required.

### Example 4: Minimum Feed Rate

The inventors have collected in vitro data from vascular catheters suggesting that continuous feeds can be administered through a 0.5 mm diameter lumen at rates of as low as 1 ml/hour without the lumen becoming obstructed.

### Example 5: Pressure Gradient & Cross-sectional Area

The inventors have calculated that with a pressure gradient of 5 cm H₂O across a 30 cm long tube a 3 mm² cross-sectional area allows venting of up to 160 ml of gas per minute from the stomach.

### Example 6: Vital Sign Monitoring from an Exemplary Gavage Tube (e.g. Trinity Tube)

The following describes experimental results for Vital Sign Monitoring from an exemplary gavage tube (e.g. trinity tube) with an adult subject, showing proof of concept for simultaneous extraction of ECG, pressure and temperature data from a single tube.

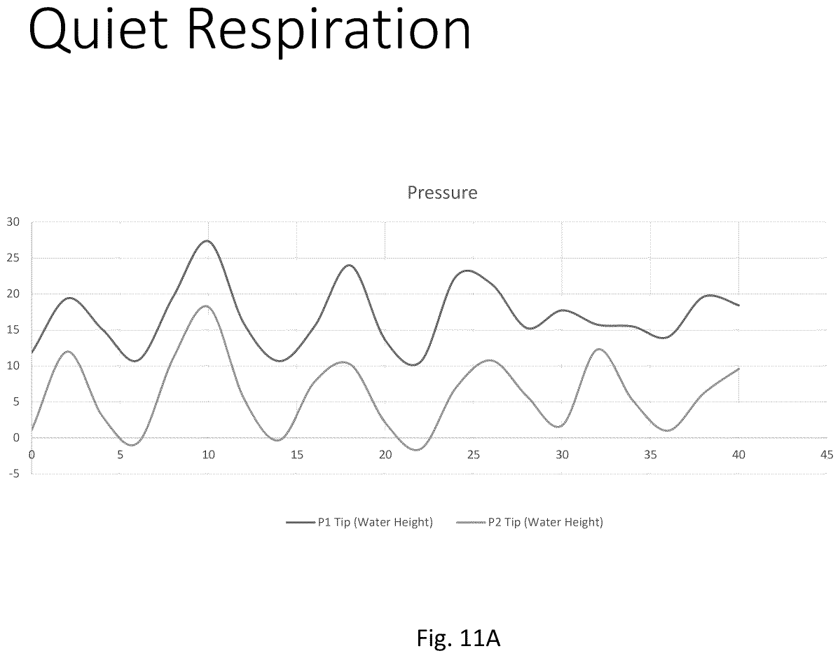

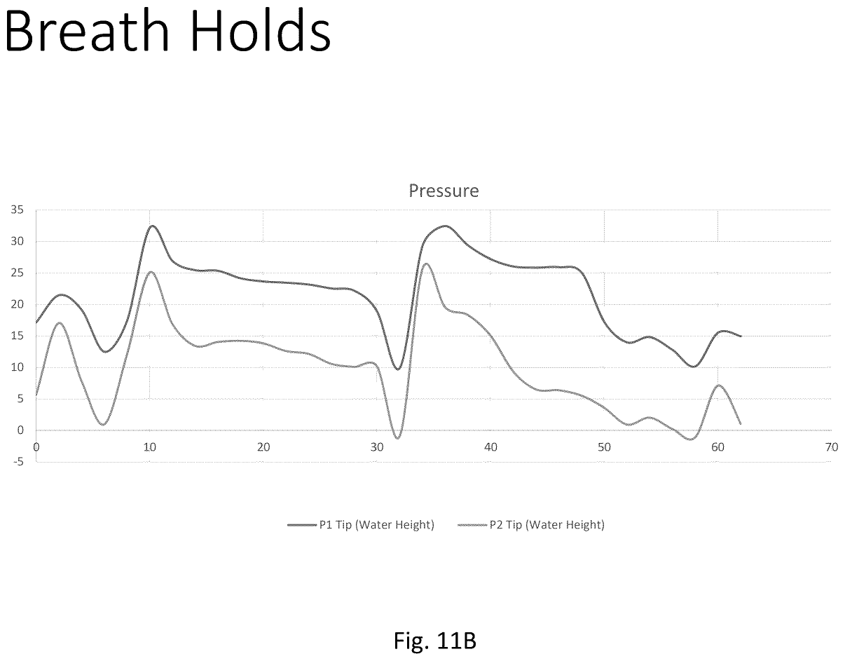

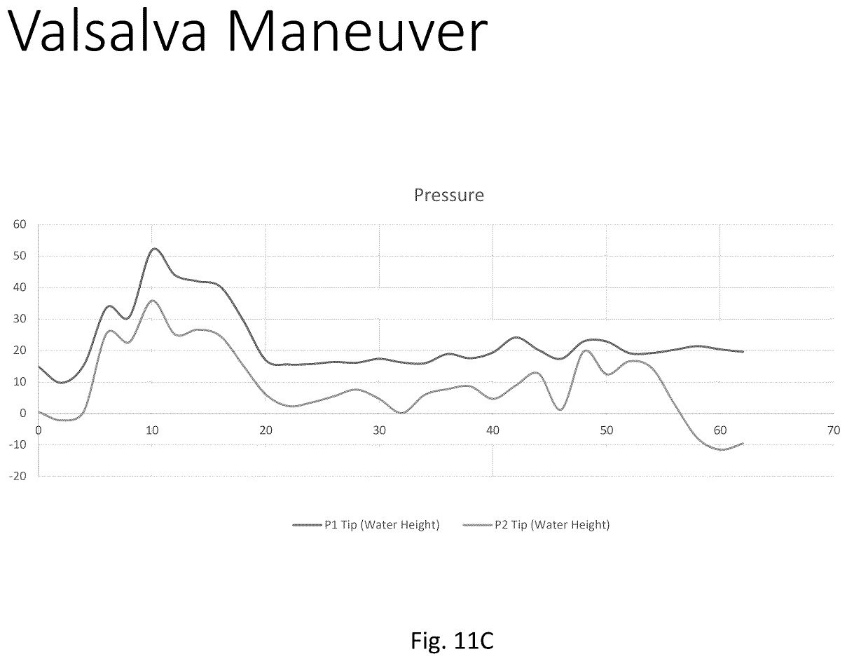

Now referring to FIGS. 11A-11C, shown are the pressure data results as generated by the trinity tube for quiet respiration (FIG. 11A), breath holds (FIG. 11B) and Valsalva Maneuver (FIG. 11C).

It is to be noted that all pressure recordings are likely taken with both pressure sensors in the esophagus rather than the hoped for placement of one esophageal and one gastric. Additionally, all pressures are positive suggesting the need, in certain instances, to re-zero the sensors prior to placement.

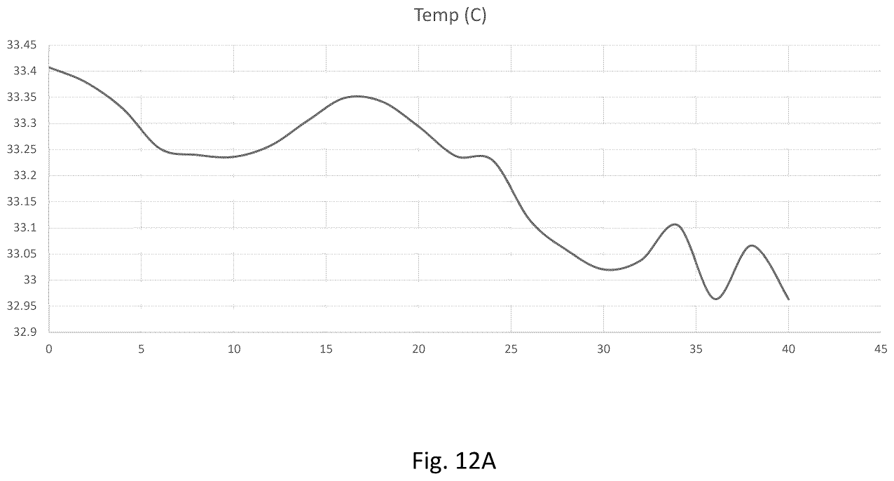

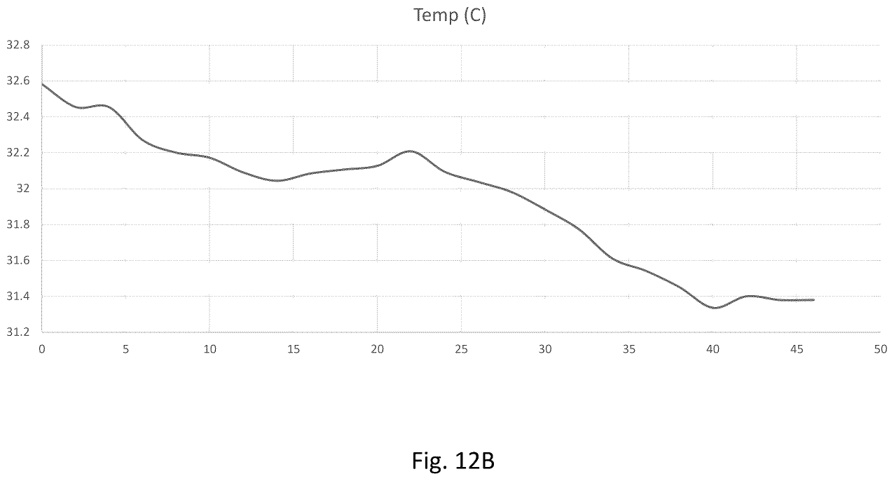

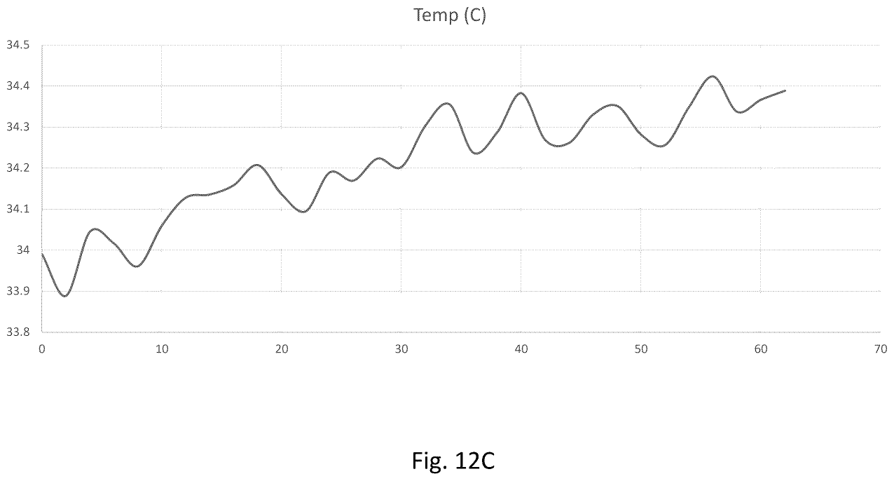

Now referring to FIGS. 12E to 12C, shown are temperature results for the subject. Initial temp was recorded at 33.4° C., then gradually feel to 30.8° C. before climbing back to 34.4° C. Subject did drink iced water during the test which may have driven the temperature down. Again, the data suggests the need, in certain instances, to calibrate the sensors prior to placement.

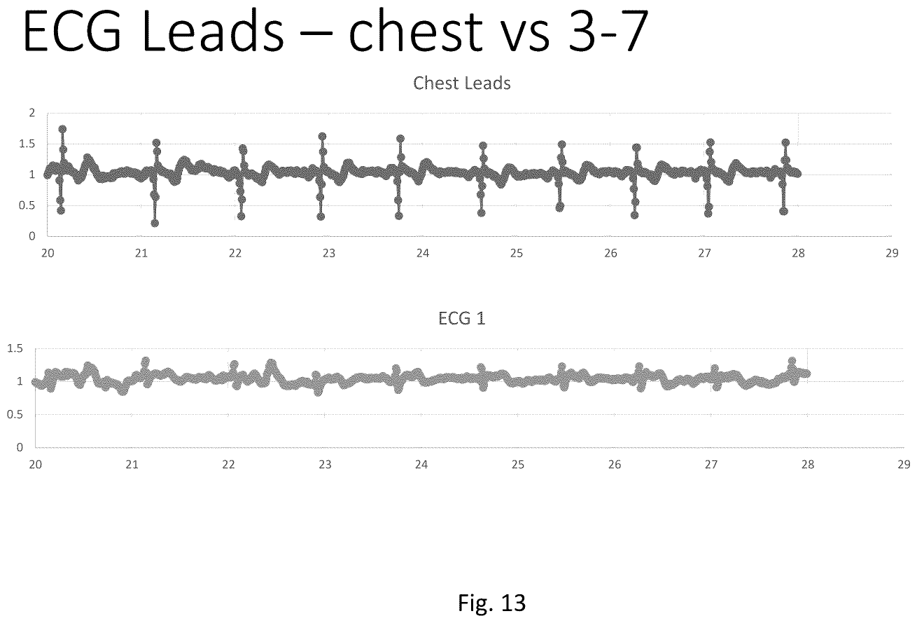

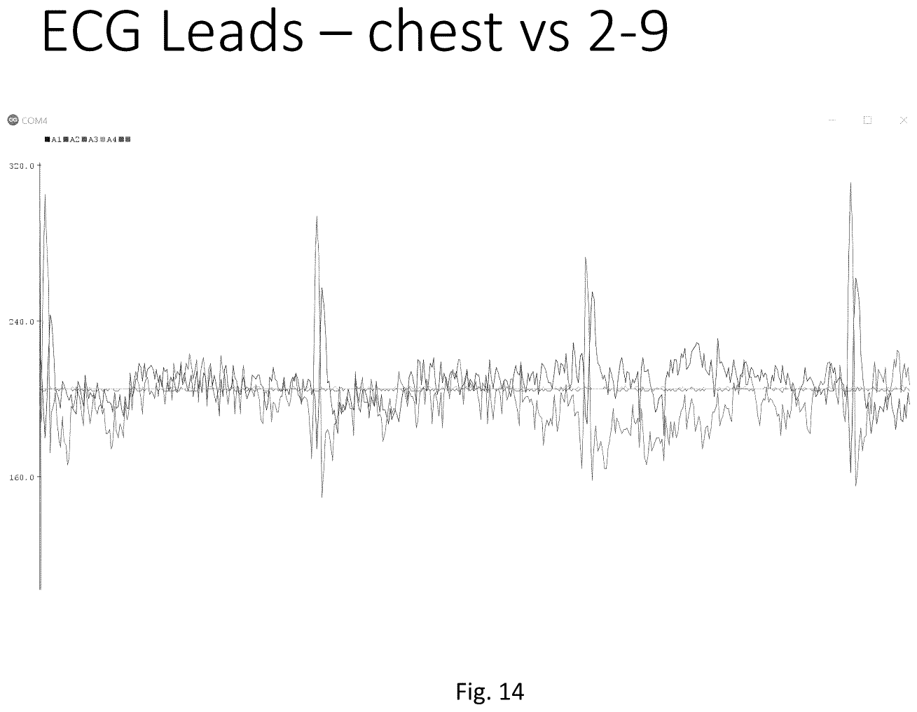

Now referring to FIG. 13 and FIG. 14, shown are ECG results for the test. The chest leads were in place for all recordings as a comparator. The initial setup is configured with EDI sensors 3-7, 4-8, 5-9. Following this, the EDI sensors were reconfigured to have 2-9, 3-8 and 4-7.

### Example 7: Development and Testing of a Multifunction Gastric Feeding Tube Capable of Vital Sign Monitoring

Infants born extremely prematurely present significant clinical and population health challenges. Advances in clinical monitoring can potentially drive improvements in survival and long-term outcomes in this vulnerable population. In the disclosed study, a multi-function catheter with ECG, pressure, and temperature sensors was developed and the performance and ideal lead location were tested in a rat model. The ECG signals, transdiaphragmatic pressure, and core body temperature of the rat were recorded from a modified multi-electrode gastric feeding tube with one pressure sensor at the tip and another pressure sensor and temperature sensor at 6 cm from the tip.

The ECG signals were obtained from esophageal electrodes in multiple locations and eventually, optimal electrode locations were identified at 4 and 6 cm from the tip of the feeding tube. Reliable pressure signals at a pressure range of 0-0.2 psi (0-14 cm H₂O) were obtained from pressure sensors placed above and below the diaphragm. A core temperature of ˜41° C. was recorded from the temperature sensor which was elevated relative to the rectal temperature measurements due to the experimental setup used.

The disclosed multifunction catheter proved to provide a reliable, strong, high resolution and low noise ECG signal from the esophageal electrodes in an animal model equivalent in size to a preterm infant. In addition, continuous pressure and temperature recordings were simultaneously extracted, with all 3 sensors contained within a less than 3 mm diameter tube as is routinely used in this population. Integration of these multiple components into a feeding tube, which is already universally used in this population purely for nutrition, will provide significant advances in vital sign monitoring while reducing risk to vulnerable preterm infants.

The long-term health of children born prematurely is a major national and international concern. Each year more than 15 million infants globally [J. L. E. C. H. MV Kinney, “March of Dimes, PMNCH, Save the Children, WHO. Born Too Soon: The Global Action Report on Preterm Birth,” World Health Organization, vol. 13, no. 5, pp. 1-126, 2012], and 350,000 infants in the US [J. A. Martin, B. E. Hamilton, M. J. K. Osterman, A. K. Driscoll, and T. J. Mathews, “Births: Final data for 2015,” National Vital Statistics Reports, vol. 66, no. 1, pp. 1-70, January 2017] are born prematurely. High-quality clinical research has driven huge advances in care and allowed intervention to become the standard of care at gestations which were considered incompatible with survival just 20-30 years ago. Infants born at 22-23 weeks of gestation, weighing 400-500 grams are now routinely admitted to many hospitals for intensive care intervention.

Preterm infants in Neonatal Intensive Care Units (NICUs) undergo numerous procedures. Gastric tube insertion is required for gavage feeding in most preterm infants because they are unable to properly coordinate their sucking, swallowing, and breathing [L. Kristoffersen, E. Skogvoll, and M. Hafstrom, “Pain Reduction on Insertion of a Feeding Tube in Preterm Infants: A Randomized Controlled Trial,” Pediatrics, vol. 127, no. 6, pp. e1449-e1454, June 2011, doi: 10.1542/PEDS.2010-3438]. Specialized medical equipment is also utilized to monitor the physiological status of patients in the NICU, who are prone to instability and fluctuations in their vital signs. The type of medical equipment employed is tailored to meet the individual needs of each patient. The standard vital signs that are typically monitored include heart rate (HR), respiratory rate (RR), blood pressure, temperature, and peripheral oxygen saturation (SpO₂) [M. Villarroel et al., “Non-contact physiological monitoring of preterm infants in the Neonatal Intensive Care Unit,” npj Digital Medicine 2019 2:1, vol. 2, no. 1, pp. 1-18, December 2019, doi: 10.1038/s41746-019-0199-5]. Temperature is another important vital sign for assessing illness [J. L. Leante-Castellanos, A. Martínez-Gimeno, M. Cidrás-Pidré, G. Martinez-Munar, A. García-González, and C. Fuentes-Gutiérrez, “Central-Peripheral Temperature Monitoring as a Marker for Diagnosing Late-Onset Neonatal Sepsis,” Pediatric Infectious Disease Journal, July 2017, doi: 10.1097/INF.0000000000001688]. An abnormal heart rate, either very low or very high, may indicate an underlying condition such as infection, pain, or illness. Irregular respiratory rate values are frequently linked to hypoxemia (low oxygen levels in the blood), hypercapnia (elevated carbon dioxide levels in the blood), or acidosis (high acidity levels in the blood). Traditional vital sign monitoring techniques necessitate the attachment of adhesive electrodes or transducers to the skin. This is problematic for preterm infants and may harm the skin, which is fragile and immature, particularly in infant born before 29 week's gestation [M. Villarroel et al., “Non-contact physiological monitoring of preterm infants in the Neonatal Intensive Care Unit,” npj Digital Medicine 2019 2:1, vol. 2, no. 1, pp. 1-18, December 2019, doi: 10.1038/s41746-019-0199-5]. Any skin breakdown raises the risk of infection, a significant morbidity in these infants who also have immature immune systems.

Despite the introduction of oxygen saturation monitoring in the 1980s, respiratory failure remains the primary cause of mortality and morbidity in extremely premature newborns, and monitoring of respiratory status has not advanced. [L. M. Muhe et al., “Major causes of death in preterm infants in selected hospitals in Ethiopia (SIP): a prospective, cross-sectional, observational study,” Lancet Glob Health, vol. 7, no. 8, pp. e1130-e1138, August 2019, doi: 10.1016/S2214-109X(19)30220-7]. At present clinical decisions on escalation and de-escalation of care are based on quantitative measures of gas exchange (CO₂ and oxygen levels) while assessments of work of breathing are entirely qualitative (subcostal recession, auscultation of air entry). A continuous quantified metric of work of breathing helps to predict impending clinical deterioration and to assess the efficacy of non-invasive modes of ventilation. In addition, a continuous metric of intrathoracic pressure could allow the clinical care team to combine the non-invasive nature of high-flow therapy with the controlled pressure delivery of continuous positive airway pressure (CPAP), optimizing both respiratory support and infant comfort and skin integrity [A. Bernatzky and G. Mariani, “Nasal high flow therapy for primary respiratory support in preterm infants,” Arch Argent Pediatr, vol. 115, no. 1, pp. e52-e53, February 2017]. Diaphragmatic activity can be quantified by the pressure-time product of the diaphragm (PTPdi), a metric that can be measured with the positioning of pressure sensors immediately above and below the diaphragm known as transdiaphragmatic pressure [T. Dassios, A. Vervenioti, S. Tzifas, S. Fouzas, and G. Dimitriou, “Validation of a non-invasive pressure-time index of the inspiratory muscles in spontaneously breathing newborn infants,” J Clin Monit Comput, vol. 37, no. 1, p. 221, February 2023, doi: 10.1007/S10877-022-00882-6].

The device disclosed herein, referred to in some examples as the “Trinity Tube” integrates three functionalities: delivering milk feeds to the stomach, venting excess gas (a by-product of non-invasive modes of ventilation) from the stomach, and vital signs monitoring such as transdiaphragmatic pressure, heart rate and temperature without the need for invasive skin-mounted sensors. The structure of the Trinity Tube and animal model specification as well as experimental procedures and steps are explained below.

The materials and methods are discussed herein:

Device Structure: Trinity Tube evolved through multiple iterations based on the mouth to esophagogastric junction (EGJ) distance and abdominal esophagus length in infants.

Feeding: the delivery of milk feeds is of critical importance to the survival and growth of extremely preterm infants [L. Kristoffersen, E. Skogvoll, and M. Hafström, “Pain Reduction on Insertion of a Feeding Tube in Preterm Infants: A Randomized Controlled Trial,” Pediatrics, vol. 127, no. 6, pp. e1449-e1454, June 2011, doi: 10.1542/PEDS.2010-3438]. Near universal use of feeding pumps allows high volumes of milk to be delivered through even a 3 Fr (1 mm) internal diameter tube.

Venting: non-invasive ventilation can cause gas to reach the stomach, leading to abdominal distention and compromised respiratory function. [A. Priyadarshi, M. Hinder, N. Badawi, M. Luig, and M. Tracy, “Continuous Positive Airway Pressure Belly Syndrome: Challenges of a Changing Paradigm,” International Journal of Clinical Pediatrics, vol. 9, no. 1, pp. 9-15, 2020, doi: 10.14740/IJCP352]. Maximizing the lumen size of the venting lumen in the disclosed device optimized the venting of gas from the stomach.

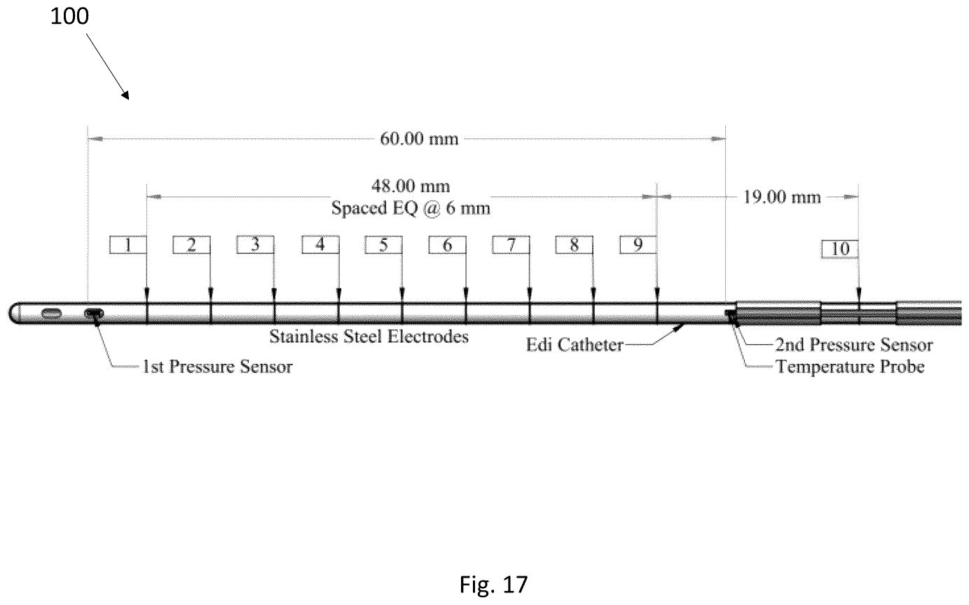

ECG: the disclosed device is comprised of a 6 Fr (2 mm) Edi (Electrical activity of the diaphragm) polyurethane catheter (Getinge, Germany) equipped with ten stainless steel electrodes, which are linearly spaced at the distal end with an inter-electrode distance of 6 mm (FIG. 17). This catheter has a single 0.8 mm diameter feeding lumen which allows delivery of up to 100 ml/hr of milk feeds. Edi catheters are primarily used in Neutrally Adjusted Ventilatory Assist (NAVA) to detect diaphragm electrical activity. Electrodes on the Edi catheter can be also used for obtaining ECG signals when located in the esophagus [P. Simmen et al., “Multichannel Esophageal Heart Rate Monitoring of Preterm Infants,” IEEE Trans Biomed Eng, vol. 68, no. 6, pp. 1903-1912 June 2021, doi: 10.1109/TBME.2020.3030162].

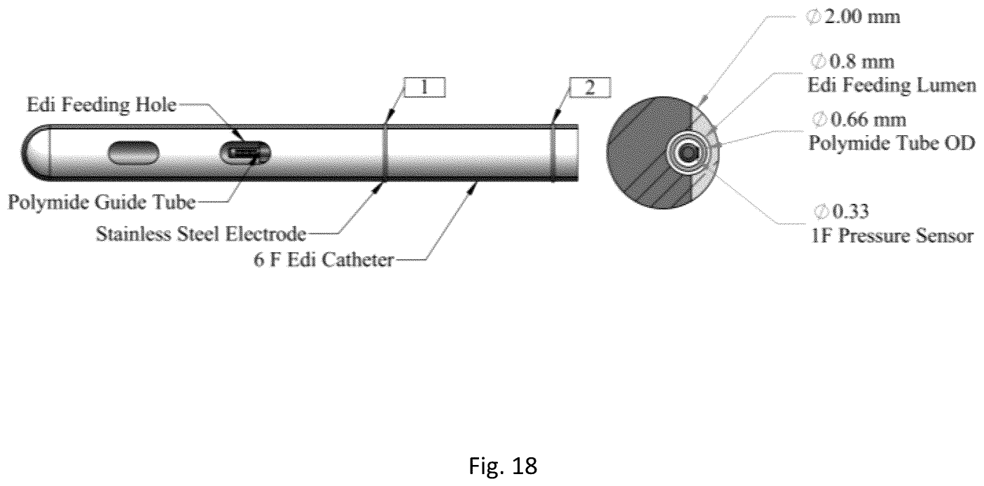

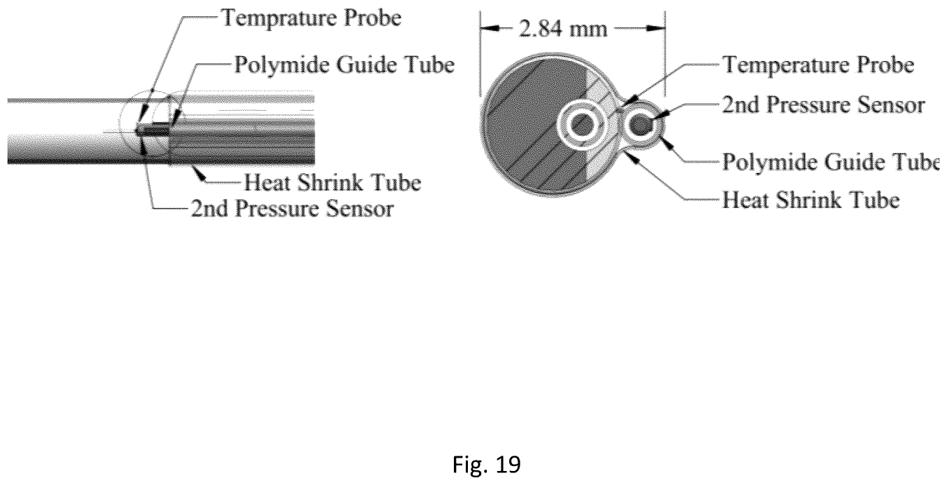

Pressure & Temperature: as shown in FIG. 18, the Trinity tube prototype has two one-French OD (0.33 mm) MEMS pressure sensors (Millar, TX), and one 0.13 mm OD type T thermocouple (5SC-TT-T-36-36, Omega Engineering Inc., CT). To securely install the first pressure sensor at the tip of the Edi catheter, a polyimide guide tube (0.508 mm ID, 0.6604 mm OD, Nordson Medical, OH) is located inside the feeding lumen of the Edi catheter and then the pressure sensor is inserted inside the guide tube (FIG. 19). The guide tube helps significantly with the insertion and removal (for re-sterilization) of the pressure sensor as Edi's polyurethane feeding lumen has a high friction surface.

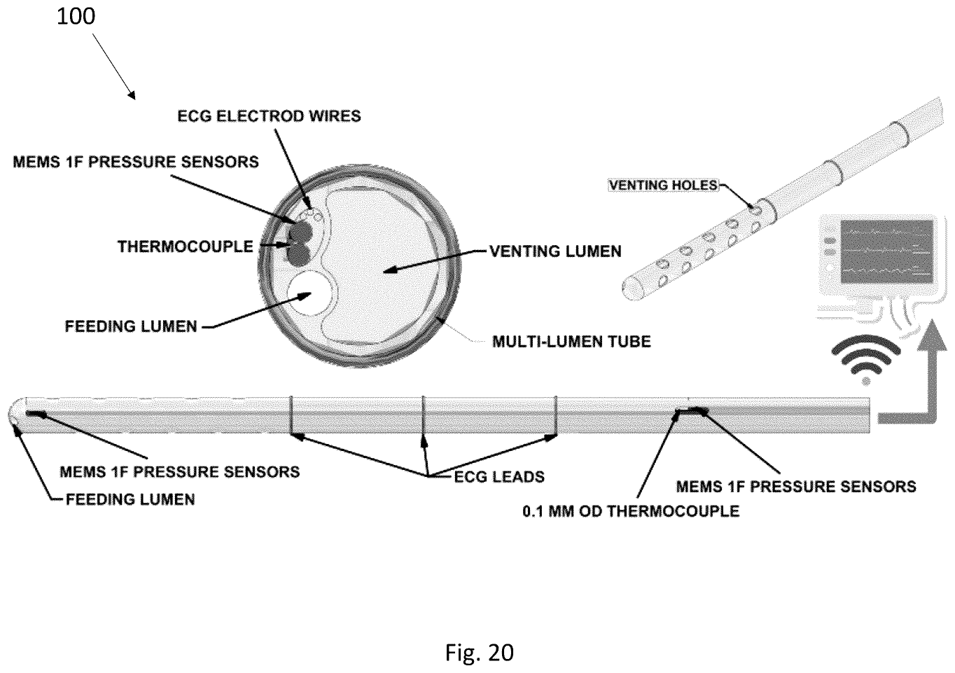

Spaced at 6 cm from the first pressure sensor, the second polyimide guide tube and the thermocouple are securely installed on the outer surface of the Edi catheter using a 3 mm ID, FDA-compliant Polyolefin heat shrink tubing. Similar to pressure sensor 1, the pressure sensor 2 is inserted into the second polyimide guide tube (FIG. 20). The resulting outside diameter of the tube with all sensors wrapped inside the heat shrink tube is now 2.84 mm.

In the disclosed device, the Edi catheter's feeding lumen was used to house the pressure sensor; however, in other embodiments, the device may comprise a 3 mm² venting lumen and a 0.67 mm to 1.33 mm ID feeding lumen. This caliber of venting lumen will allow the extraction of up to 140 ml of air from the stomach at a pressure gradient of 6 cm H₂O (0.085 psi). Also, in some embodiments, the disclosed device may have a fewer number of esophageal electrodes in locations that provide optimum strong signals. In addition, in some embodiments, a separate lumen will be used to contain all sensor wires. The dimensions and placement of all features are shown in FIG. 20.

Data acquisition units (DAQ) were used to acquire precise and accurate data from the sensors and ECG electrodes. For ECG data collection, an ECG module with low and high pass filters (ECG Click, Mikro Elektronika, Belgrade, Serbia) amplifies the ECG signals and sends them to a high precision, high-speed USB DAQ unit (16-bit, 250,000 Hz Max, MCC USB-1608GX, Measurement Computing Corporation, MA) where signal data is displayed on and stored to a computer using MCC DAQami Software.

The pressure and temperature data was collected directly from the sensors through a multi-functional high precision and medium speed USB DAQ (24-bit, 1000 Hz, OM-DAQ-USB-2400, Omega Engineering Inc., CT) and stored using Omega DAQ Central Software (version 1.0.7, Omega Engineering Inc., CT). Both ECG modules and pressure sensors are supplied with a 5.00 V input voltage. The range of output voltage for ECG modules is +2.4 V and the precision of the pressure sensor is 25 μV/mmHg (or 1.293 mV/psi).

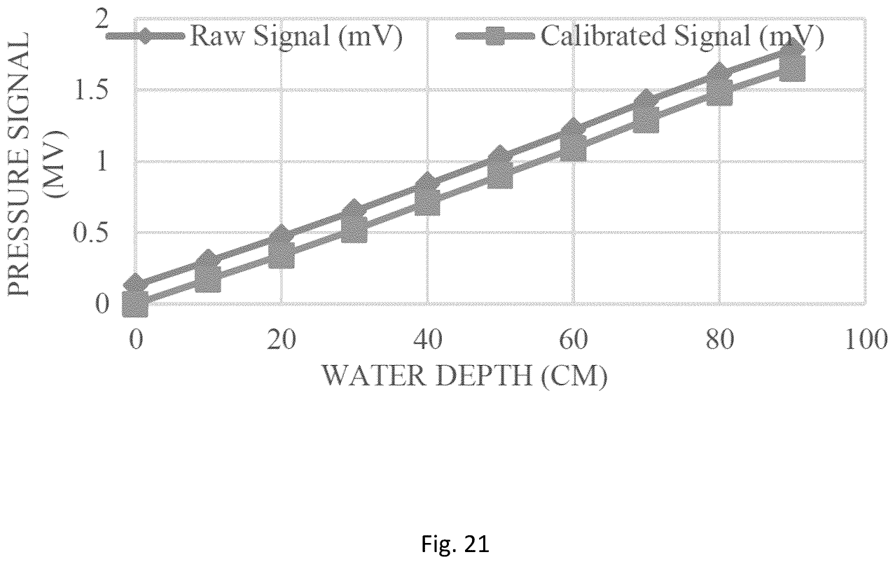

Benchtop experiments were performed to calibrate the sensors, reduce electrical noises and ensure ECG signals were obtained successfully. For instance, ECG data was successfully received from an adult subject using three chest electrodes. In addition, MEMS pressure sensors were calibrated using a 120 cm tall water column. First, the sensors' output signals were measured at room (1 atmosphere) pressure, then each sensor was inserted into the water column where pressure signals (in mV) were collected at 10 cm increment depth markings using the high-resolution DAQ unit. The results (FIG. 21) showed that the pressure sensors' output signals are linear with an offset equal to the room air pressure. In addition, consistent temperature data was collected from the thermocouple using the Omega DAQ and the sensor was calibrated at 0 and 100° C.

Animal Model Description: rats have been used as animal models for preterm birth research due to their short gestational period, low cost, and ease of handling. While no animal model perfectly mimics the human condition, rats have been shown to develop similar symptoms and complications as preterm infants and have been a useful tool for investigating the mechanisms and complications of preterm birth [H. Hagberg, C. Mallard, and B. Jacobsson, “Role of cytokines in preterm labour and brain injury,” BJOG, vol. 112, no. SUPPL. 1, pp. 16-18, March 2005, doi: 10.1111/J.1471-0528.2005.00578.X].

An adult female (Body Weight: 722 g) Sprague-Dawley rat (Charles River Laboratories, Malvern, PA) was used in this experiment. The rat was anesthetized with isoflurane gas (2%-3%) in 100% oxygen before body weight was assessed. The trachea was cannulated, and the animal was mechanically ventilated (Harvard Apparatus). The right jugular vein and one carotid artery were cannulated (PE-50) for fluid/drug delivery and blood pressure measurement, respectively. The carotid arterial catheter was connected to a pressure transducer (CWE DTX-1) and heart rate (HR) was calculated beat by beat from pulsatile blood pressure using Spike 2 software (CED, Cambridge).

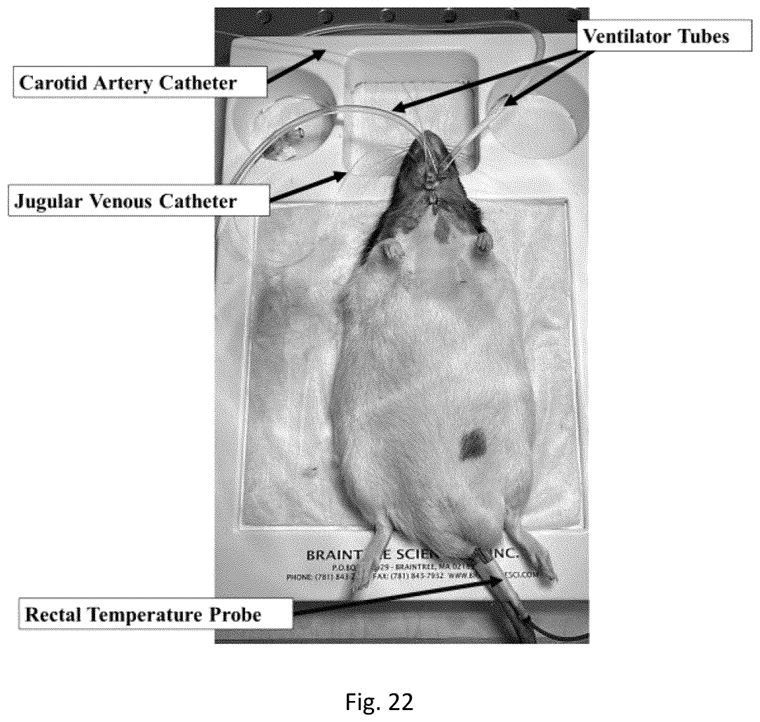

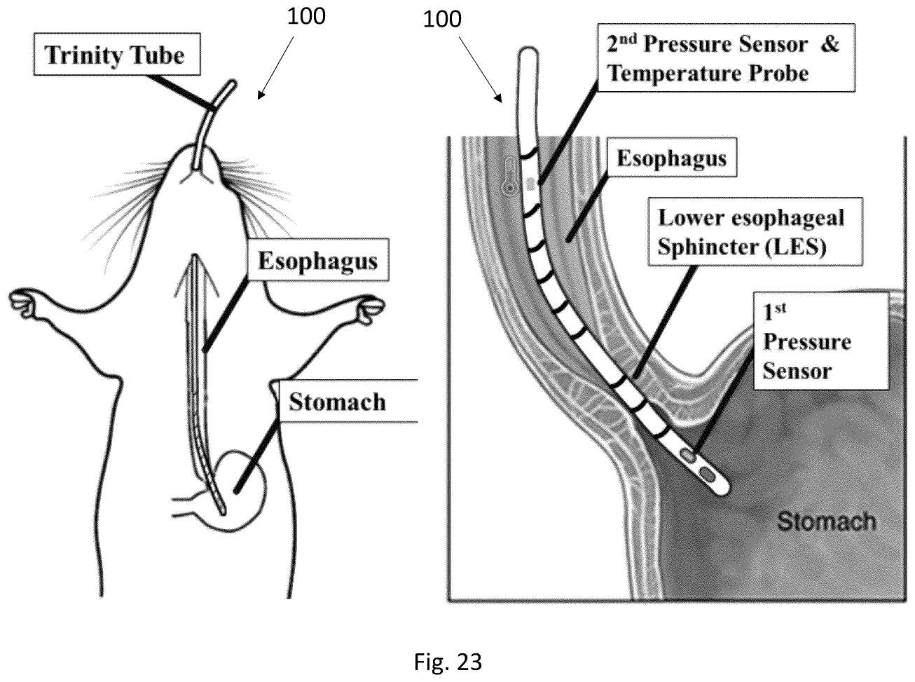

The life support tubes setup as well as the Trinity Tube located in the animal are shown in FIG. 22 & FIG. 23. At the end of the experiment, the rat was euthanized with an intravenous injection of saturated potassium chloride (>200 mg/kg).

Equipment Setup: an electronics box containing the DAQs, four ECG modules, sensor connection ports, circuit board and power supply was prepared to enable easier transportation and enhanced protection of the electronics. Standard sensor connection ports located in the electronics box ensure a convenient and secure connection of the Edi catheter, pressure sensors and thermocouple cables during the experiment. The Edi catheter included a male 14 pins cable connector with 10 active pins each connected to a stainless electrode on the tube. This Edi connector was attached to the electronics box female port where it was split into 10 individual single-pin connectors allowing to switch the leads connected to each ECG amplifying module. Each ECG module required at least three electrodes with two used as bipolar leads and one as the ground lead that helps to minimize ECG artifact. A total of four ECG modules were used to receive signals from multiple electrodes at the same time. Therefore, with a shared ground, at least 9 electrodes were required to receive four separate signals.

Method: the experiments were performed in two phases where phase I focuses on ECG data collection and phase II on pressure and temperature data gathering.

ECG: A total of ten experiments were conducted in phase I while the animal was receiving respiratory support. A sample rate of 1000 Hz was used during the data acquisition. In the first five experiments, the most proximal electrode (electrode #10) was used as ground and the remaining electrodes (electrodes #2 to #9) were used as bipolar leads. The most distal electrode (electrode #1) was left disconnected as it was anticipated to be located in the stomach with no surface contact with the esophageal wall. Table 1 shows the configuration of electrodes and ECG modules. In the first experiment, the tube was inserted 13 cm into the animal's esophagus to ensure the first pressure sensor is located below the diaphragm inside the stomach and the signals were collected. Then the tube was retraced to 12 cm, 11 cm, 10 cm and 8 cm and ECG signals were collected respectively (Table 2). During these five experiments, the animal was receiving respiratory support at 60 breaths per minute (BPM).

TABLE 1
CONFIGURATION OF ELECTRODES

| ECG | Bipolar | Ground |
|---|---|---|
| Module | Electrodes | Electrode |
| 1 | 2 and 9 | 10 |
| 2 | 3 and 8 | 10 |
| 3 | 4 and 7 | 10 |
| 4 | 5 and 6 | 10 |

TABLE 2
TUBE LOCATIONS IN EACH EXPERIMENT

| Experiment | Tube Location |
|---|---|
| # | (cm) |
| 1 | 13 |
| 2 | 12 |
| 3 | 11 |
| 4 | 10 |
| 5 | 8 |

In the second five experiments, the tube was inserted 12 cm and only three electrodes and one ECG module were used. Optimal placement at 12 cm insertion was based on ultrasound imaging demonstrating the tip of the tube 2 cm below the diaphragm and the signals achieved in the first five examples and is explained in the result section. Table 3 shows the electrodes' configurations for a respiratory rate of 60 BPM.

TABLE 3
ELECTRODES SELECTION FOR RESPIRATORY
RATE OF 60 BPM

| Experiment | Bipolar | |
|---|---|---|
| # | Electrodes | Ground |
| 6 | 2 and 4 | 9 |
| 7 | 3 and 6 | 9 |
| 8 | 4 and 6 | 10 |
| 9 | 4 and 9 | 10 |
| 10 | 4 and 7 | 10 |

Pressure & Temperature: In phase II, pressure and temperature data were received at two respiratory rate of 60 BPM and 80 BPM and with data acquisition (DAQ) sample rate of 4, 10, and 20 Hz. The reason for using multiple sample rates was to find the highest possible sample rate which provided an acceptable waveform of intrathoracic pressure while optimizing signal to noise.

The results are discussed herein:

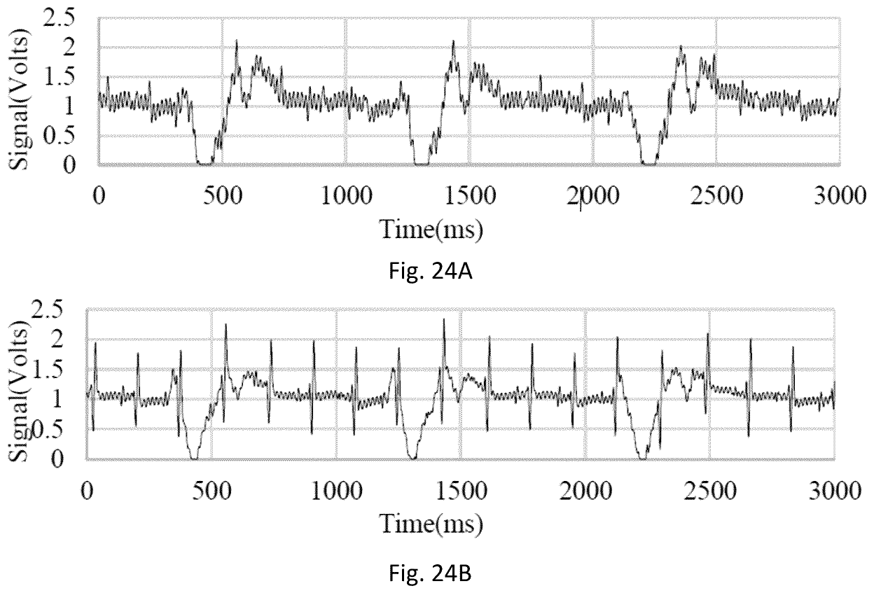

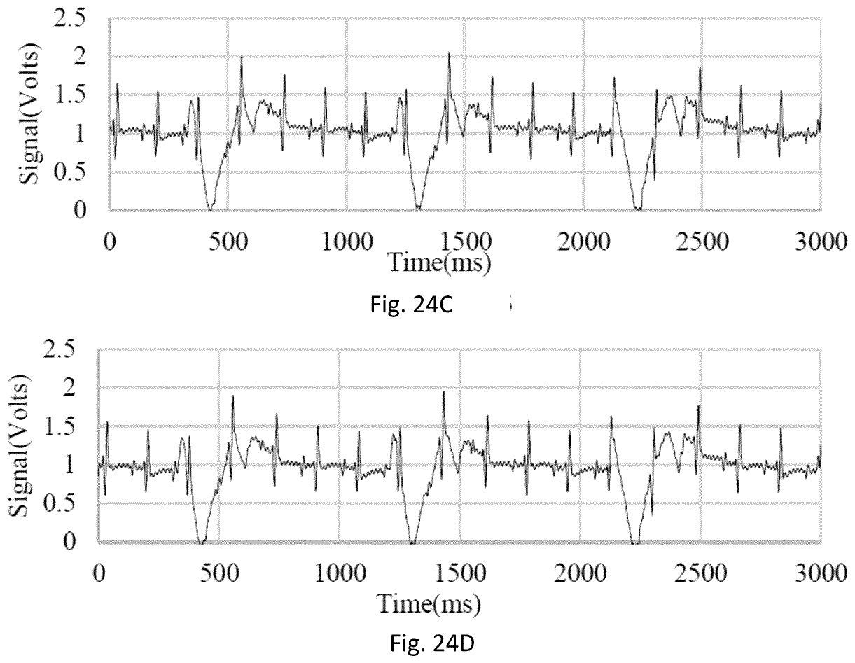

ECG: The electrocardiogram signals received from the electrodes are shown in FIGS. 24A, 24B, 24C, and 24D for a 3 s duration where the tube is inserted 13 cm.

FIGS. 24A-24D display depolarization signals from ECG modules 1-4. Module 1's signal strength (max 2.2V) exceeds the others, but significant noise appears due to poor surface contact in the esophagus. This suggests electrode 2 is in the stomach, lacking esophagus wall contact. Module 2 has reduced noise with electrode 3 farther from the catheter tip. ECG 3 and 4 have cleaner signals with less noise, yet reduced intensity since electrodes are closer.

In FIGS. 24A-24D, in addition to the ECG signal, a strong negative deflection can be seen every 1 second, reflecting the impact of regular breaths from the mechanical ventilator. To ensure the source of noise in ECG 1 is due to poor contact, the catheter was retracted in 1 cm intervals and ECG signals were observed. The results showed that as the tip of the catheter was further away from the stomach and all electrodes were in the esophagus, the noise was reduced significantly, and a cleaner signal was received.

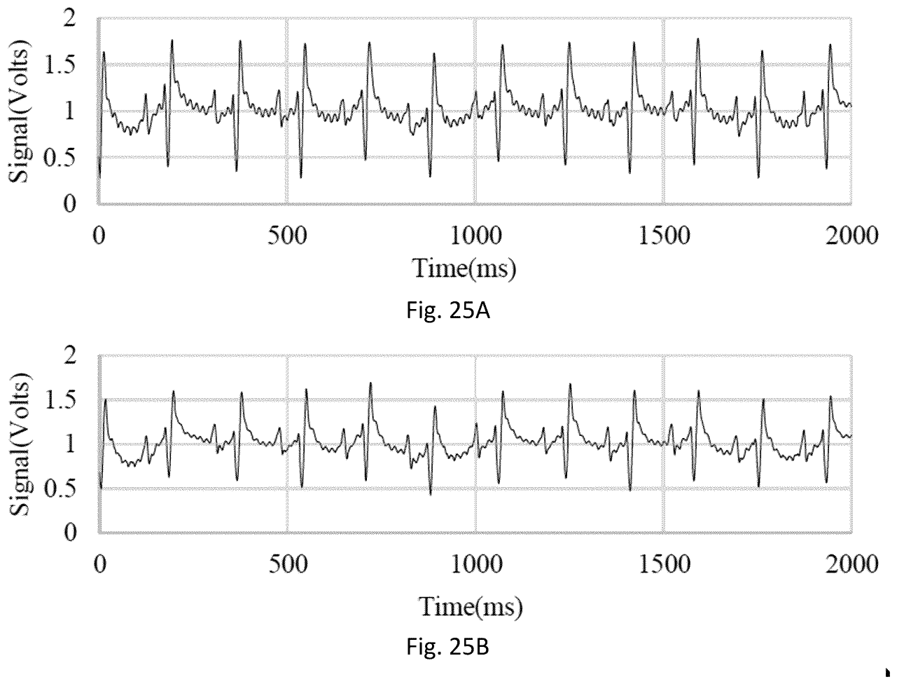

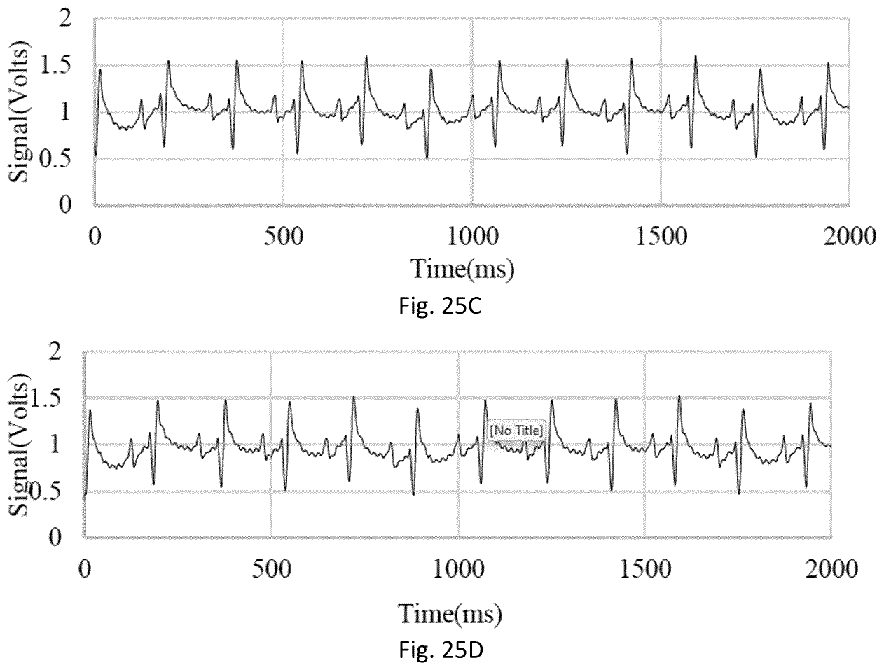

FIGS. 25A-25D show the signals from the electrodes when the tube was inserted 8 cm. The results above showed that a reliable, strong, high resolution and low noise ECG signal can be obtained from the esophageal electrodes depending on where they are located in the esophagus and how far they are from each other. It is also important to make sure that the tip of the catheter, where the first pressure sensor is located, is always in the esophagus to obtain valid pressure readings. Using a handheld ultrasound imager, the tip of the catheter was tracked when it was retracted. The imager showed that the tip of the catheter at 2 cm separated from the stomach. Therefore, at an insertion length of 12 cm it was ensured the first pressure sensor is still in the stomach while most of the esophageal electrodes show a strong, low noise signal.

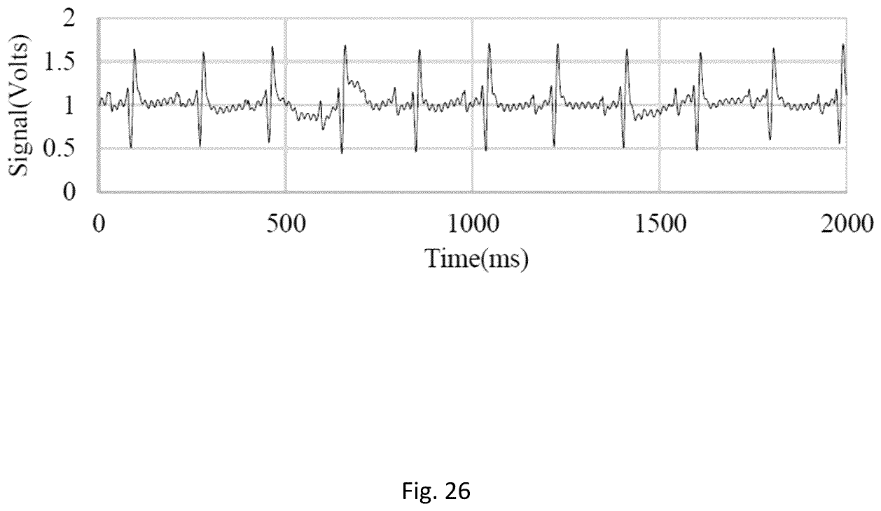

In the rest of the experiments, as mentioned before, three electrodes were used interchangeably with different spacing and ground electrode according to Table 3 to find the strongest signal with the lowest noise. After reviewing all 5 experiments, electrodes 4 and 7 were chosen as bipolar leads and electrode 10 was chosen as ground. The results of ECG signals for this selection are shown in FIG. 26.

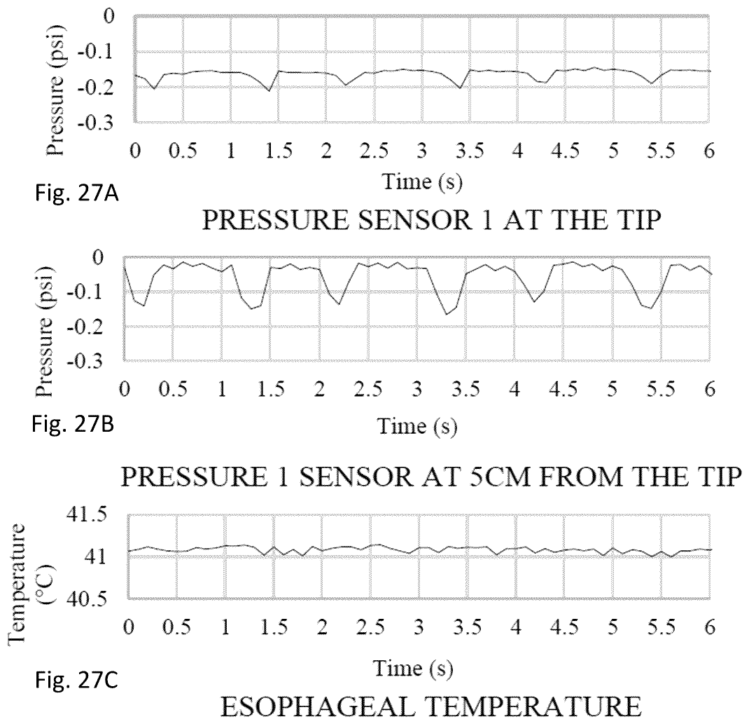

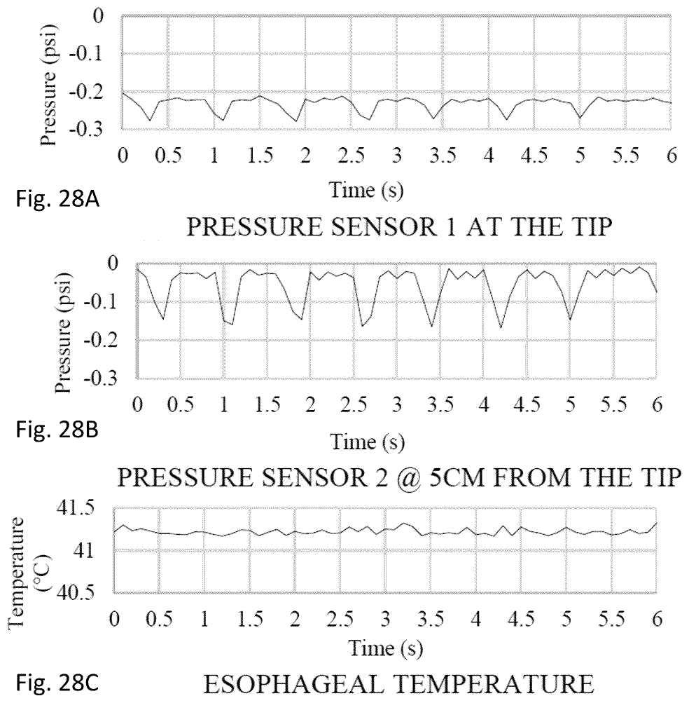

Pressure & Temperature: the esophageal and gastric pressure and temperature were first measured at respiratory rates of 60 BPM when the DAQ was set at sample rates of 4 Hz, 10 Hz, and 20 Hz. The data received from the DAQ showed that a sample rate of 10 Hz is slow enough to provide a good resolution as well as accurate data. This sample rate was then used as a standard to obtain more pressure and temperature values at 80 BPM. The results of pressure and temperature measurements at 10 Hz for the respiratory rate of 60 and 80 BPM are shown in FIG. 27 and FIG. 28, respectively.

The results in FIGS. 27 & 28 demonstrate stable high-resolution pressure sensing above and below the diaphragm. In this anesthetized animal there is no spontaneous effort, so pressures on either side of the diaphragm change in parallel, with the subdiaphragmatic pressures being dampened by the resistance of the static diaphragm. Pressure deflections of 0-0.2 psi (0-14 cm H₂O) were readily seen and are in keeping with the pressure levels expected in rat models and human newborns. Pressure traces readily differentiate between ventilator rates of 60 and 80 breaths/minute.

The pressure-time product of the diaphragm (PTPdi), a clinically validated metric of work of breathing, was calculated in a spontaneously breathing human infant by simultaneously measuring pressure from above and below the diaphragm [G. Dimitriou, A. Tsintoni, A. Vervenioti, D. Papakonstantinou, and T. Dassios, “Effect of prone and supine positioning on the diaphragmatic work of breathing in convalescent preterm infants,” Pediatr Pulmonol, vol. 56, no. 10, pp. 3258-3264 October 2021, doi: 10.1002/PPUL.25594]. Clinical teams may apply this metric to guide the escalation and de-escalation of ventilatory support and to hasten the detection of adverse clinical events such as pneumothorax.

In addition, a continuous metric of intrathoracic pressure allows titration of gas flow rates on high-flow nasal cannula therapy to target a desired end-expiratory pressure optimizing lung recruitment while preventing the need for escalation to more invasive modes of support.

Temperature readings were stable in the range of 41.0-41.5° C. Rectal temperatures measured simultaneously were 37.0-37.5° C. However, it is noted in the experimental setup that the thorax of the animal was situated directly underneath a heat lamp which may have caused significant local warming.

ECG signals were obtained from the esophageal electrodes in an animal model equivalent in size to the extremely preterm infant. Continuous pressure and temperature recordings were simultaneously extracted, with all 3 sensors contained within a tube with diameter <3 mm diameter tube as is routinely used in this population. In summary, the integration of multiple components into a feeding tube that is already used for nutrition in this population can result in significant advances in vital sign monitoring, while reducing risks to vulnerable preterm infants.

### Example 8: Development and Testing of a Multifunction Feeding Tube Capable of Respiratory, Cardiac and Temperature Monitoring

Respiratory support in preterm infants is increasingly provided by non-invasive methods. Continuous positive airway pressure (CPAP) provides a positive end expiratory pressure (PEEP) to the lungs but requires careful positioning and intensive nursing input. High flow nasal cannula (HFNC) is simpler to position but provides variable PEEP. All newborns requiring CPAP/HFNC have a gavage tube in place for routine clinical care. A pressure sensor placed within a gavage tube could provide continuous PEEP monitoring, potentially allowing titrated PEEP while receiving HFNC support. Additional sensors could allow quantification of work of breathing (transdiaphragmatic pressure gradient) and monitoring of heart rate and temperature.

To develop a multifunction gavage tube capable of simultaneous pressure, temperature and ECG monitoring and to demonstrate feasibility of monitoring in an animal model equivalent in size to the preterm newborn.

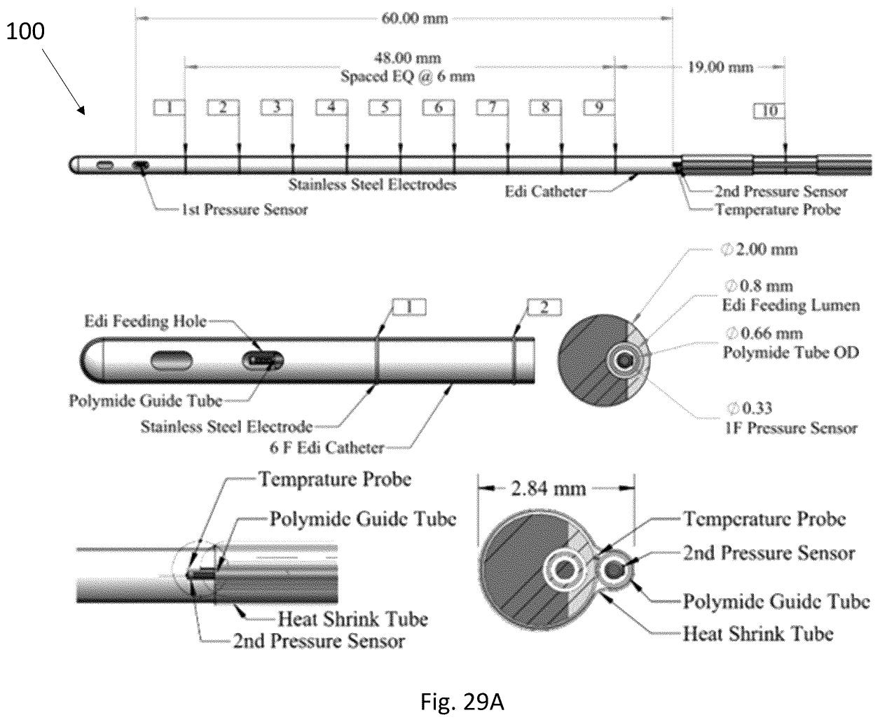

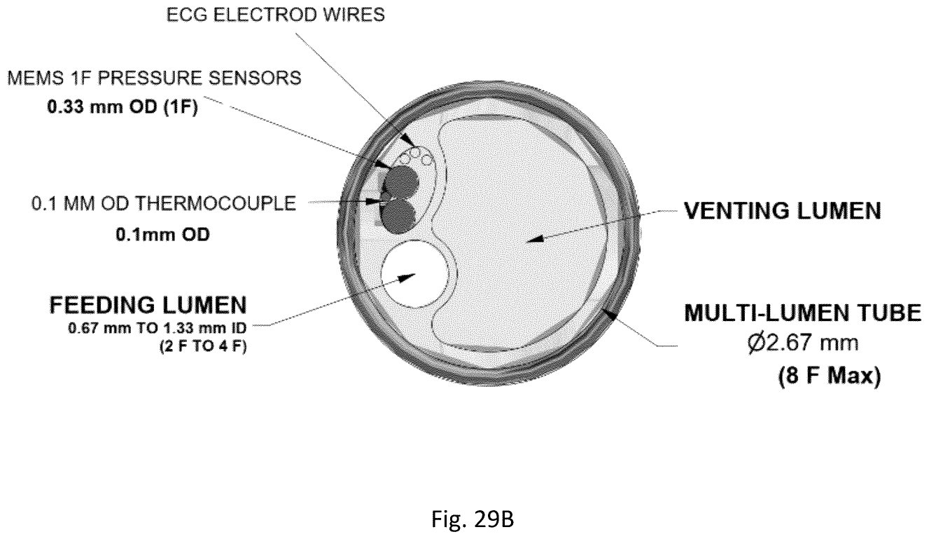

A 1 Fr (0.33 mm) pressure sensor was inserted (Millar, TX) within the lumen of a 6 Fr (2 mm) Neurally-adjusted ventilatory assist (NAVA) catheter (Getinge, Sweden) using a polyamide guide tube. A 2nd 0.33 mm pressure sensor and a 0.13 mm thermocouple (Omega Engineering, CT). were attached to the external surface 6 cm from the catheter tip using heat shrink tubing (FIGS. 29A & 29B). The total diameter of the device was 2.84 mm. ECG signals were obtained from indwelling sensors at 2-7 cm from the tip (FIG. 29A). The device was placed in an adult (722 g) Sprague-Dawley rat (Charles River Laboratories, Malvern, PA) under isoflurane anesthesia with IACUC approval. The tip of the tube was confirmed to be 2 cm below the diaphragm by ultrasound. Pressure and temperature were recorded at a frequency of 10 Hz, ECG at 250 Hz. At the end of the experiment, the rat was euthanized by injection of potassium chloride.

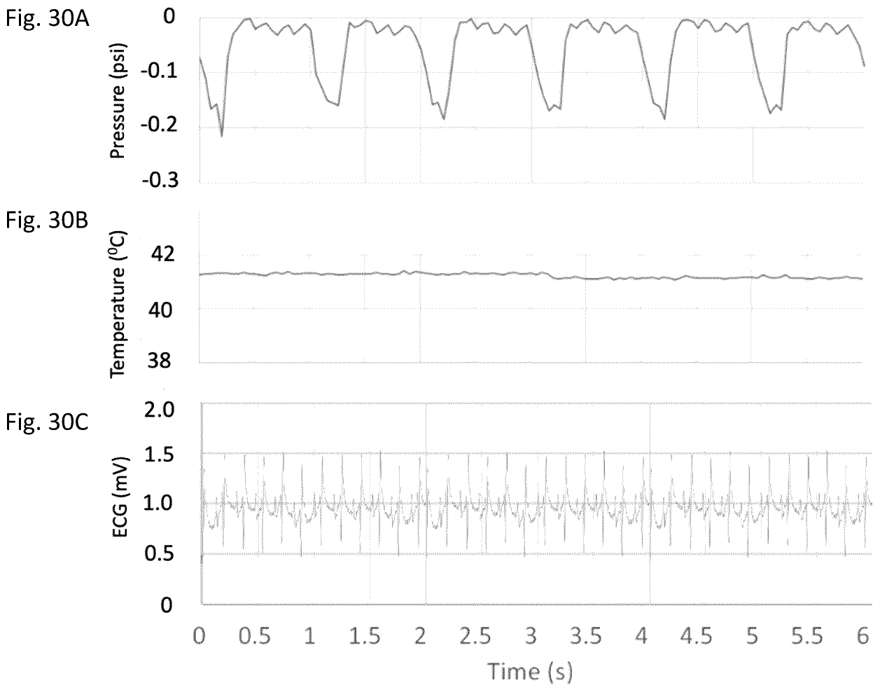

Reliable pressure signals at a range of 0-14 cm H₂O (0-0.2 psi) were obtained from pressure sensors placed both above and below the diaphragm (FIG. 30A). A core temperature of ˜41° C. was recorded (FIG. 30B). Optimal ECG signals at a voltage range of 0-2 mV were obtained from esophageal electrodes placed at 4 and 6 cm from the tube tip, with ground placed at 9 cm (FIG. 30C).

The disclosed multifunction catheter provided continuous, reliable, high resolution esophageal pressure, temperature and ECG monitoring in an animal model equivalent in size to the preterm infant, with all sensors contained within a <3 mm diameter tube as is routinely used in the preterm infant. In some embodiments, an exemplary gavage tube of the present invention may comprise any of these elements in a in a device less than 3 mm in diameter (FIG. 29B).

### Example 9: Trinity Tube

A minimally invasive device for NICU nurses and neonatologists that maintains skin integrity, delivers sufficient food, vents excessive gas, provides airway pressure feedback, and monitors vital signs wirelessly.

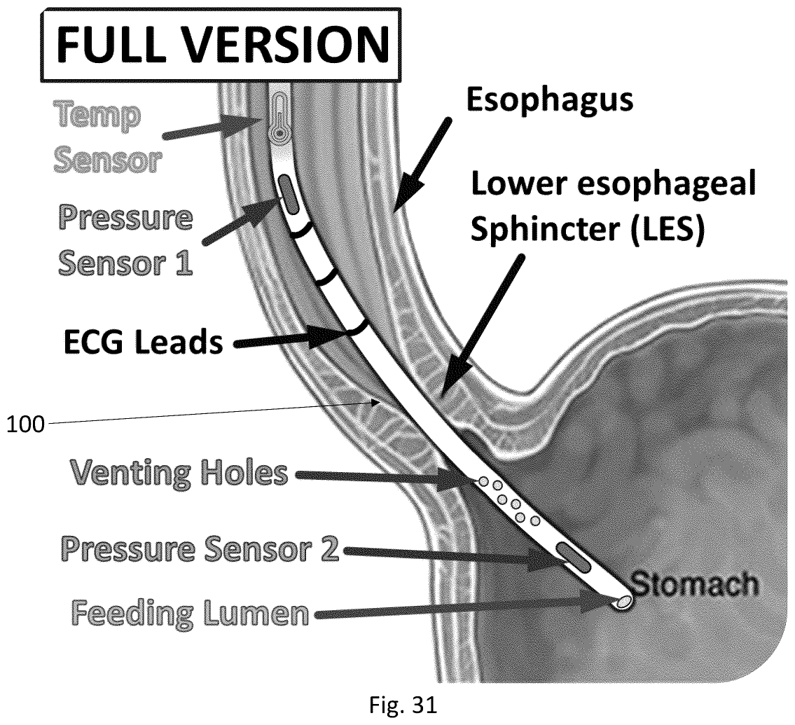

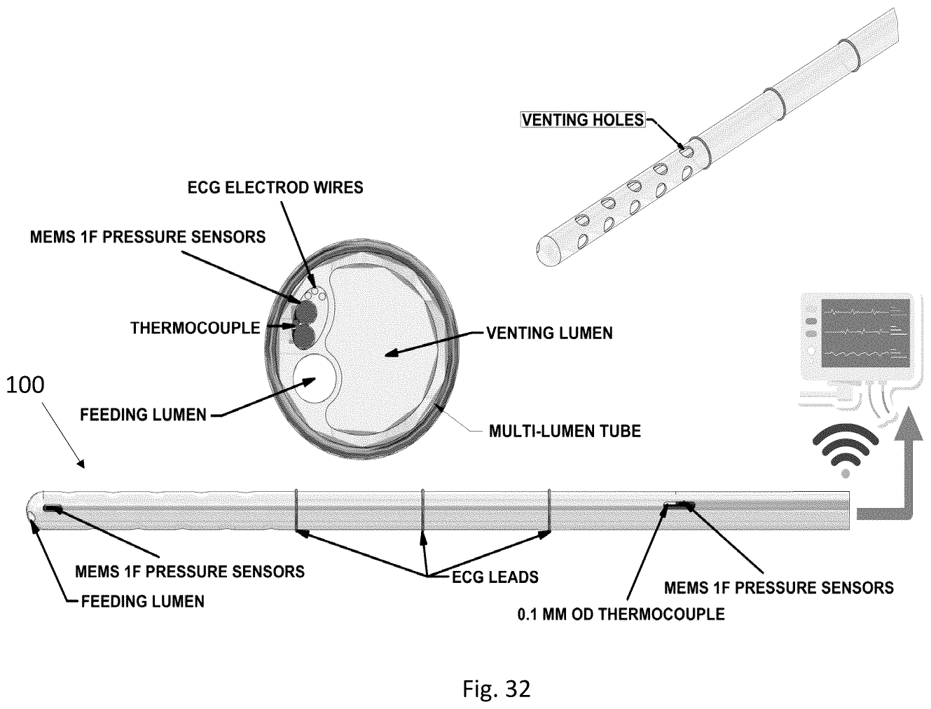

FIG. 31 shows placement in the body of a subject of an exemplary gavage tube according to aspects of the present invention. FIG. 32 shows various views of an exemplary gavage tube and gavage tube system according to aspects of the present invention.

The following publications are each incorporated by reference in their entireties:

Roberts, C. T., et al. (2016). “Nasal High-Flow Therapy for Primary Respiratory Support in Preterm Infants.” N Engl J Med 375 (12): 1142-1151.

Dimitriou, G., et al. (2021). “Effect of prone and supine positioning on the diaphragmatic work of breathing in convalescent preterm infants.” Pediatr Pulmonol 56 (10): 3258-3264.

Simmen, Patrizia et al. (2021). “Multichannel Esophageal Heart Rate Monitoring of Preterm Infants.” IEEE transactions on bio-medical engineering vol. 68, 6:1903-1912.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A gavage tube comprising:
a multi-lumen tube comprising a plurality of channels having a proximal end, a distal end and a length therebetween;
wherein the plurality of channels comprises a first channel forming a feeding lumen, and a second channel forming a monitoring lumen, and each channel extends parallel to each other along at least a portion of the length of the tube; and
wherein the proximal end is positioned outside of a subject's body and the distal end is positioned in the subject's stomach.

2. The gavage tube of claim 1, wherein the multi-lumen tube has an outer diameter ranging between 1.0 and 10.0 mm.

3. The gavage tube of any preceding claim, wherein the multi-lumen tube has an inner diameter ranging between 0.5 and 8.0 mm.

4. The gavage tube of claim 1, wherein an outer surface of the multi-lumen tube comprises a plurality of textured markings for enhanced visibility.

5. The gavage tube of claim 1, wherein the first channel comprises an axial feeding hole at the distal end of the channel.

6. The gavage tube of claim 1, wherein the first channel is fluidly connected to one selected from the group consisting of: a pump and a syringe.

7. The gavage tube of claim 1, wherein the first channel has a diameter ranging between 0.3 and 5.0 mm.

8. The gavage tube of any preceding claim, wherein the plurality of channels comprises a third channel forming a venting lumen.

9. The gavage tube of claim 8, wherein the third channel comprises a plurality of lateral venting holes passing through the wall of the third channel, and through the wall of the multi-lumen tube.

10. The gavage tube of claim 9, wherein the plurality of lateral venting holes have a diameter ranging between 0.5 and 3.0 mm.

11. The gavage tube of claim 9, wherein the plurality of lateral venting holes are positioned at the distal end of the multi-lumen tube.

12. The gavage tube of claim 9, wherein the plurality of lateral venting holes are positioned at the distal 2 cm of the multi-lumen tube.

13. The gavage tube of claim 9, further comprising a venting chamber fluidly connected to the third channel positioned at the proximal end of the multi-lumen tube.

14. The gavage tube of claim 13, wherein the venting chamber comprises a first opening configured to be used for gastric gas profiling and an escape valve configured to allow gas efflux.

15. The gavage tube of claim 14, wherein the escape valve is a single direction valve.

16. The gavage tube of claim 1, wherein the second channel further comprises a first lateral opening passing through the wall of the second channel, and through the wall of the multi-lumen tube, positioned 3-20 cm from the distal end of the tube.

17. The gavage tube of claim 16, further comprising at least one temperature sensor positioned in the first opening of the second channel.

18. The gavage tube of claim 17, wherein the at least one temperature sensor may be selected from the group consisting of a thermocouple, a thermistor, a thermos-diode, and combinations thereof.

19. The gavage tube of claim 18, wherein the second channel further comprises a second lateral opening passing through the wall of the second channel, and through the wall of the multi-lumen tube, positioned 3-7 cm from the distal end of the tube.

20. The gavage tube of claim 19, further comprising a second pressure sensor positioned in the second lateral opening of second channel.

21. The gavage tube of claim 1 or 17, further comprising a plurality of electrode rings positioned on an outer wall of the multi-lumen tube and configured to be used as ECG or EMG sensors; wherein the plurality of electrode rings are positioned along at least a portion of the length of the multi-lumen tube.

22. The gavage tube of claim 21, wherein the plurality of electrode rings comprises between 2 and 10 electrode rings.

23. The gavage tube of claim 21, wherein the plurality of electrode rings comprises at least a first, second and third electrode ring, wherein the first electrode ring is positioned 3 cm from the distal end of the multi-lumen tube, the second electrode ring is positioned 9 cm from the distal end of the multi-lumen tube, and the third electrode ring is positioned 10 cm from the distal end of the multi-lumen tube.

24. A method of providing nutrition to a subject, comprising:
inserting a gavage tube comprising: a multi-lumen tube comprising a plurality of channels having a proximal end, a distal end and a length therebetween through a nasal or oral cavity of the subject; wherein a first channel forms a feeding lumen having a proximal opening and distal axial opening in the multi-lumen tube, a second channel forms a monitoring lumen having a proximal opening and one or more lateral openings in the multi-lumen tube comprising one or more sensors positioned in each opening, and each channel extends parallel to each other along at least a portion of the length of the tube; and wherein the proximal end of the multi-lumen tube is positioned outside of a subject's body and the distal end is positioned in the subject's stomach, and;
providing nutrition through the feeding lumen; and
measuring at least one biometric of the subject with the one or more sensors during the step of providing nutrition through the feeding lumen.

25. A method of providing nutrition to a subject while simultaneously venting gas from the subject's stomach, comprising:
inserting a gavage tube comprising: a multi-lumen tube comprising a plurality of channels having a proximal end, a distal end and a length therebetween through a nasal or oral cavity of the subject; wherein a first channel forms a feeding lumen having a proximal opening a distal axial opening in the multi-lumen tube, a second channel forms a monitoring lumen having a proximal opening and one or more lateral openings in the multi-lumen tube comprising one or more sensors positioned in each opening; and a third channel forms a venting lumen having a proximal opening and a plurality of lateral vent holes in the multi-lumen tube, and each channel extends parallel to each other along at least a portion of the length of the tube; and wherein the proximal end of the multi-lumen tube is positioned outside of a subject's body and the distal end is positioned in the subject's stomach, and;
providing nutrition through the feeding lumen;
allowing the venting lumen to facilitate removal of gases from the subject's stomach during the step of providing nutrition through the feeding lumen;
measuring at least one biometric of the subject with the one or more sensors during the step of providing nutrition through the feeding lumen.

26. The method of claim 24 or 25, wherein the one or more sensors is selected from the group consisting of: temperature sensor, pressure sensor, light sensor, infrared sensor.

27. The method of claim 24 or 25, wherein the gavage tube further comprises a plurality of electrode rings positioned on an outer surface of the multi-lumen tube configured to measure ECG or EMG signals from the subject; and the method further comprises the step of measuring ECG or EMG signals from the subject with the plurality of electrode rings during the step of providing nutrition through the feeding lumen.
